(19) United States
(12) Patent Application Publication
(10) Pub. No.: US 2020/0248022 A1
(43) Pub. Date: Aug. 6, 2020

(54) AQUEOUS INK COMPOSITION, PRINTING HEAD SET, INK JET PRINTING METHOD, AND INK JET PRINTING APPARATUS

(71) Applicant: Seiko Epson Corporation, Tokyo (JP)

(72) Inventor: Kohei ISHIDA, Matsumoto (JP)

(21) Appl. No.: 16/776,589

(22) Filed: Jan. 30, 2020

(30) Foreign Application Priority Data
Jan. 31, 2019 (JP) 2019-015708

(51) Int. Cl. C09D 11/38; C09D 11/108; C09D 11/102; C09D 11/322; B41M 5/00; B41J 2/01

(52) U.S. Cl. CPC C09D 11/38; C09D 11/108; C09D 11/102; C08K 5/17; B41M 5/0023; B41J 2/01; C09D 11/322

(57) ABSTRACT

An aqueous ink composition contains at least one organic solvent in a proportion of 15.0% or less relative to the total mass of the ink composition and in which the content of organic solvents having a normal boiling point of more than 280.0° C. is limited to 3.0% or less of the total mass of the ink composition. The aqueous ink composition is ejected from a printing head having a circulation flow channel through which the ink composition circulates in the printing head.

The present application is based on, and claims priority from, JP Application Serial Number 2019-015708, filed Jan. 31, 2019, the disclosure of which is hereby incorporated by reference herein in its entirety.

### BACKGROUND

### 1. Technical Field

The present disclosure relates to an aqueous ink composition, a printing head set, an ink jet printing method, and an ink jet printing apparatus.

### 2. Related Art

Ink jet printing methods, which enable high-definition printing with a relatively simple apparatus, have been developed in various fields. For example, some ink jet printing methods have been studied for printing images on non-absorbent printing media and on printing media having poor ink absorbance. More specifically, printing on a non-ink-absorbent or poorly ink-absorbent printing medium, such as food packaging bags, has been studied.

JP-A-2017-186472 discloses a printing method using an ink containing 1 part by mass of a resin and 2 to 9 parts by mass of a nitrogen-containing solvent that have a difference in solubility parameter (SP) of within 3. According to the cited disclosure, the printing method enables consistent ink ejection and can produce imagery having high rub-fastness.

Inks containing organic solvent in a high proportion are unlikely to dry quickly on plastic films. For example, when a printed plastic film is rolled up, a printed image may be transferred onto the rear side of the medium or cause blocking (sticking). It is anticipated that reducing the organic solvent content will enable the ink to dry quickly and reduce transfer of a printed image, or sticking, thereby enhancing the fastness of the resulting image. Unfortunately, the decrease in the proportion of the organic solvent implies that the organic solvent having a moisturizing function decreases, accordingly causing the ink to dry quickly at the nozzles of the printing head and reducing ejection consistency. It is thus difficult to achieve both high fastness and satisfactory ejection consistency.

### SUMMARY

1. According to an aspect of the present disclosure, there is provided an ink jet printing method including an application step of ejecting an aqueous ink composition from a printing head to apply the aqueous ink composition onto a poorly absorbent or non-absorbent printing medium. The aqueous ink composition contains at least one organic solvent in a proportion of 1.0% to 13.0% relative to the total mass of the ink composition. The at least one organic solvent includes an organic solvent having a normal boiling point of 150.0° C. to 280.0° C., and the content of organic solvents having a normal boiling point of more than 280.0° C. is limited to 3.0% or less of the total mass of the ink composition. The printing head has a circulation flow channel through which the aqueous ink composition circulates in the printing head.

2. Another aspect of the present disclosure is directed to an aqueous ink composition containing at least one organic solvent in a proportion of 15.0% or less relative to the total mass of the ink composition, and in which the content of organic solvents having a normal boiling point of more than 280.0° C. is limited to 3.0% or less of the total mass of the ink composition. The aqueous ink composition is ejected for printing from a printing head having a circulation flow channel through which the aqueous ink composition circulates in the printing head.

3. In the aqueous ink composition of 2, the total content of the at least one organic solvent may be 1.0% by mass to 13.0% by mass.

4. In the aqueous ink composition according to 2 or 3, the at least one organic solvent includes an organic solvent having a normal boiling point of 170.0° C. to 280.0° C.

5. In the aqueous ink composition according to any one of 2 to 4, the at least one organic solvent include an organic solvent having a normal boiling point of 280.0° C. or less selected from the group consisting of polyols, alkylene glycol ethers, and alkanediols having a carbon number of 5 or more.

6. The aqueous ink composition according to any one of 2 to 5 may further contain polymer particles.

7. In the aqueous ink composition of (6), the content of the polymer particles may be 1.0% by mass to 15.0% by mass.

8. In the aqueous ink composition according to 6 or 7, the polymer particles have a glass transition temperature of −30.0° C. to 50.0° C.

9. The aqueous ink composition according to any one of 2 to 8 may be circulated at a rate of 1.0 g/min to 7.0 g/min per printing head.

10. In an embodiment of the aqueous ink composition according to any one of 2 to 9, the printing head may have a pressure chamber operable to apply a pressure to the aqueous ink composition to eject the aqueous ink composition through a nozzle. The circulation flow channel has a route that causes the aqueous ink composition flowing from the pressure chamber to circulate.

11. In an embodiment of the aqueous ink composition according to any one of 2 to 10, the printing head may be a line head having nozzles in an arrangement with a length more than or equal to the width of the printing medium and may be operable to apply the aqueous ink composition onto the printing medium during one scanning operation.

12. In the aqueous ink composition according to any one of 2 to 11, the total content of the at least one organic solvent may be 1.0% by mass to 10.0% by mass.

13. Another aspect of the present disclosure is directed to a printing head set including an aqueous ink composition and a printing head. The aqueous ink composition contains at least one organic solvent in a proportion of 15.0% or less relative to the total mass of the ink composition, and in which the content of organic solvents having a normal boiling point of more than 280.0° C. is limited to 3.0% or less of the total mass of the ink composition. The printing head has a circulation flow channel through which the aqueous ink composition circulates and is operable to eject the aqueous ink composition, for printing, onto a printing medium.

14. In the printing head set of 13, the printing head may be a line head having nozzles in an arrangement with a length more than or equal to the width of a printing medium and may be operable to print on the printing medium during one scanning operation.

15. Another aspect of the present disclosure is directed to an ink jet printing method including an application step of ejecting an aqueous ink composition from a printing head to apply the aqueous ink composition onto a printing medium. The aqueous ink composition contains at least one organic solvent in a proportion of 15.0% or less relative to the total mass of the aqueous ink composition, and in which the content of organic solvents having a normal boiling point of more than 280.0° C. limited to 3.0% or less of the total mass of the aqueous ink composition. The printing head includes a circulation flow channel through which the aqueous ink composition circulates in the printing head.

16. In the ink jet printing method of 15, the printing head may be a line head having nozzles in an arrangement with a length more than or equal to the width of the printing medium and may perform the application step on the printing medium during one scanning operation.

17. In the ink jet printing method of 16, the application step may include transporting the printing medium at a rate of 30.0 m/min or more.

18. The ink jet printing method according to any one of 15 to 17 may further include a drying step of drying the aqueous ink composition applied onto the printing medium with a drying mechanism during the application step.

19. In the ink jet printing method according to any one of 15 to 18, the printing medium may have a surface temperature of 45.0° C. or less in the application step.

20. The ink jet printing method according to any one of 15 to 19 may further include a post-application heating step of heating the printing medium after the application step.

21. In the ink jet printing method according to any one of 15 to 20, the printing medium may be a polymer film.

22. In the ink jet printing method according to any one of 15 to 21, the aqueous ink composition may be circulated at a rate of 1.0 g/min to 7.0 g/min per printing head.

23. In the ink jet printing method according to any one of 15 to 17, the aqueous ink composition applied onto the printing medium may not be subjected to drying with a drying mechanism during the application step.

24. According to further aspect of the present disclosure, an ink jet printing apparatus is provided. The ink jet printing apparatus includes an aqueous ink composition containing at least one organic solvent in a proportion of 15.0% or less relative to the total mass of the ink composition. In the aqueous ink composition, the content of organic solvents having a normal boiling point of more than 280.0° C. is limited to 3.0% or less of the total mass of the ink composition. The ink jet printing apparatus also includes a printing head including a circulation flow channel through which the aqueous ink composition circulates. The printing head is operable to eject the aqueous ink composition to apply the ink composition onto a printing medium.

25. In the ink jet printing apparatus of 24, the aqueous ink composition may contain at least one organic solvent in a proportion of 1.0% to 13.0% relative to the total mass of the aqueous ink composition, and the at least one organic solvent includes an organic solvent having a normal boiling point of 150.0° C. to 280.0° C. The printing medium is poorly absorbent or not absorbent.

### BRIEF DESCRIPTION OF THE DRAWINGS

FIG. 1 is a schematic diagram of an ink jet printing apparatus according to an embodiment of the present disclosure.

FIG. 2 is a schematic view of the carriage and vicinity of the ink jet printing apparatus according to an embodiment of the present disclosure.

FIG. 3 is a block diagram of an ink jet printing apparatus according to an embodiment of the present disclosure.

FIG. 4 is a schematic sectional view of a printing head of an ink jet printing apparatus.

FIG. 5 is a schematic sectional view of the circulation chamber and vicinity of the printing head.

FIG. 6 is a schematic sectional diagram of a portion of a line head printing apparatus.

### DESCRIPTION OF EXEMPLARY EMBODIMENTS

Some embodiments of the present disclosure will now be described. The following embodiments will be described by way of example. The implementation of the subject matter of the disclosure is not limited to the following embodiments, and various modifications may be made within the scope and spirit of the disclosure. Not all of the components disclosed in the following embodiments are necessarily essential for the subject matter disclosed herein.

### 1. Aqueous Ink Composition

The aqueous ink composition disclosed herein contains at least one organic solvent and water. The total content of the organic solvent is 15.0% or less relative to the total mass of the ink composition. In addition, the content of organic solvents having a normal boiling point of more than 280.0° C. is limited to 3.0% or less of the total mass of the ink composition. The aqueous ink composition of the present disclosure is ejected for printing from a printing head having a circulation flow channel through which the aqueous ink composition circulates in the printing head.

### 1. 1. Organic Solvent

The aqueous ink composition disclosed herein contains at least one organic solvent in a proportion of 15.0% by mass or less. In addition, the content of organic solvents having a normal boiling point of more than 280.0° C. is limited to 3.0% or less of the total mass of the ink composition. Such an aqueous ink composition can dry quickly and provides printed items having high fastness and, in addition, can be consistently ejected (superior in anti-clogging). The aqueous ink composition has all of these advantages simultaneously. The organic solvent may be soluble in water. In the present disclosure, the measures of the fastness of a printed item include rub-fastness, lamination strength, and resistance to blocking and image transfer to the rear side. Fixability is involved in fastness.

The organic solvent functions to increase the wettability of the aqueous ink composition on the printing medium and to improve the moisture retention of the aqueous ink composition. When the organic solvent content is 15.0% by mass or less, the ink composition is unlikely to clog nozzles because of high moisture retention and can dry quickly. Such an ink composition does not leave much of the organic solvent in the resulting printed item, thus producing printed items having high fastness. Also, by controlling the organic solvent contents as above, the surface tension of the ink composition is reduced to enable ink droplets to easily fly out of the nozzles when ejected from the printing head, and the ink composition can sufficiently wet and spread across the surface of the printing medium.

In addition, since the ink composition can dry quickly, a problem called bleeding, which is caused by ink droplets gathering together on the printing medium, can be reduced. Accordingly, the surface temperature of the printing medium can be kept relatively low during application of the ink composition.

Examples of the organic solvents include esters, alkylene glycol ethers, cyclic esters, nitrogen-containing solvents, and polyhydric alcohols. The nitrogen-containing solvents include cyclic amides and acyclic amides. An example of the acyclic amides is an alkoxyalkylamide.

Beneficially, the normal boiling point of the organic solvent contained in the aqueous ink composition may be 280.0° C. or less and more beneficially in the range of 150.0° C. to 280.0° C., 170.0° C. to 280.0° C., or 180.0° C. to 270.0° C. In some embodiments, an organic solvent having a normal boiling point of 190.0° C. to 270.0° C. or 200.0° C. to 250.0° C. may be used. Use of organic solvent having a normal boiling point in such a range increases the fastness of the resulting printed item and reduces clogging. The normal boiling point of the organic solvent can be measured by a known method.

The content of organic solvents having a normal boiling point of more than 280.0° C. is 3.0% by mass or less and may be, by mass, 2.5% or less, 2.0% or less, 1.5% or less, or 1.0% or less. In some embodiments, the content of organic solvent having a normal boiling point of more than 280.0° C. may be, by mass, 0.5% or less or 0.3% or less. In an embodiment, such an organic solvent is not essential; hence, the content thereof may be 0.0% by mass. Such an aqueous ink composition can dry quickly when applied onto the printing medium and exhibit high adhesion to the printing medium, producing printed items having high fastness.

Examples of the organic solvent having a normal boiling point of more than 280.0° C. include glycerin and polyethylene glycol monomethyl ether.

Exemplary esters that can be used in the aqueous ink composition include glycol monoacetates, such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxybutyl acetate; and glycol diesters, such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, diethylene glycol acetate butyrate, propylene glycol acetate propionate, propylene glycol acetate butyrate, dipropylene glycol acetate butyrate, and dipropylene glycol acetate propionate.

Exemplary cyclic esters include lactones, such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nanolactone, ε-nanolactone, and ε-decanolactone; and compounds derived from these lactones by substituting an alkyl group having a carbon number of 1 to 4 for the hydrogen of the methylene group adjacent to the carbonyl group of the lactone.

The nitrogen-containing solvents include acyclic amides and cyclic amides. An example of the acyclic amides may be an alkoxyalkylamide.

Examples of the alkoxyalkylamide include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-isopropoxy-N,N-dimethylpropionamide, 3-isopropoxy-N,N-diethylpropionamide, 3-isopropoxy-N,N-methylethylpropionamide, 3-tert-butoxy-N,N-dimethylpropionamide, 3-tert-butoxy-N,N-diethylpropionamide, and 3-tert-butoxy-N,N-methylethylpropionamide.

The acyclic amide may be an alkoxyalkylamide represented by the following general formula (1):

R¹—O—CH₂CH₂—(C═O)—NR²R³ (1)

wherein R¹ represents an alkyl group having a carbon number of 1 to 4, and R² and R³ each independently represent a methyl group or an ethyl group. The alkyl group having a carbon number of 1 to 4 may be linear or branched, and examples thereof include methyl, ethyl, n-propyl, isopropyl, n-butyl, sec-butyl, isobutyl, and tert-butyl. Compounds represented by formula (1) may be used individually or in combination.

Exemplary cyclic amides include lactams, such as 2-pyrrolidone, 1-methyl-2-pyrrolidone, 1-ethyl-2-pyrrolidone, 1-propyl-2-pyrrolidone, and 1-butyl-2-pyrrolidone. These cyclic amides are beneficial for facilitating the formation of the coating of the resin particles, and 2-pyrrolidone is more beneficial.

Exemplary alkylene glycol ethers include alkylene glycol monoethers and alkylene glycol diethers. In some embodiments, alkyl ethers may be used. More specifically, examples of such an alkylene glycol ether include alkylene glycol monoalkyl ethers, such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, and tripropylene glycol monobutyl ether; and alkylene glycol dialkyl ethers, such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methylethyl ether, diethylene glycol methylbutyl ether, triethylene glycol dimethyl ether, triethylene glycol diethyl ether, triethylene glycol dibutyl ether, triethylene glycol methylbutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

The carbon number of the alkylene glycol that is a portion of the alkylene glycol ether may be from 2 to 8, 2 to 6, or 2 to 4. In some embodiments, the carbon number of such an alkylene glycol may be 2 or 3. The alkylene glycol forming a portion of the alkylene glycol ether may be a condensate produced by condensation between hydroxy groups of alkylene glycol molecules. The number of condensations of such an alkylene glycol may be from 1 to 4 or 1 to 3, for example, 2 or 3.

The ether forming a portion of the alkylene glycol ether may be an alkyl ether. The carbon number of the alkyl ether may be from 1 to 4 or 2 to 4.

Alkylene glycol ethers help the aqueous ink composition permeate and wet the printing medium and are thus beneficial for forming high-quality images. In some embodiments, alkylene glycol monoethers may be used from this viewpoint.

Exemplary polyhydric alcohols include 1,2-alkanediols, such as ethylene glycol, propylene glycol (also known as propane-1,2-diol), 1,2-butanediol, 1,2-pentanediol, 1,2-hexanediol, 1,2-heptanediol, and 1,2-octanediol; and other polyhydric alcohols (polyols), such as diethylene glycol, dipropylene glycol, 1,3-propanediol, 1,3-butanediol (also known as 1,3-butylene glycol), 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, trimethylolpropane, and glycerin.

The polyhydric alcohols can be classified into alkanediols and other polyols.

Alkanediol is a diol of an alkane having a carbon number of 5 or more. The carbon number of the alkane may be from 5 to 15, 6 to 10, or 6 to 8. In some embodiments, 1,2-alkanediol may be selected.

Other polyols may be derived from an alkane having a carbon number of 4 or less or may be an intermolecular condensate produced by condensation between hydroxy groups of such alkane-derived polyol molecules having a carbon number of 4 or less. The carbon number of the alkane may be 2 or 3. The number of hydroxy groups in the polyol molecule is 2 or more and may be 5 or less, for example, 3 or less. When the polyol is in the form of an intermolecular condensate, the number of intermolecular condensations is 2 or more and may be 4 or less or 3 or less. Polyhydric alcohols may be used individually or in combination.

Alkanediols and polyols function mainly as a penetrating solvent and/or a moisturizing agent. Alkanediols are rather penetrating solvents, and polyols are rather moisturizing agents.

Alkanediols are much likely to function as a penetrating agent and can impart high wettability to the ink composition on the printing medium, thus being beneficial for forming high-quality images.

Polyols are highly hydrophilic and help the aqueous ink composition retain moisture, thus being beneficial for reducing clogging. In particular, use of polyols having a normal boiling point of 280.0° C. or less helps the aqueous ink composition to dry quickly and produce printed items having high fastness.

In some embodiments, the aqueous ink composition may contain at least one organic solvent selected from the group consisting of polyols, alkylene glycol ethers, and alkanediols having a carbon number of 5 or more. The ink composition containing such organic solvents can favorably wet and spread across the printing medium and is less likely to clog nozzles, thus forming high-quality images. In addition, since the surface tension of the ink composition decreases, ink droplets can be easily released from the nozzles when ejected, thus easy to eject. Also, such an ink composition can dry quickly, and the resulting printed item has high fastness.

From these viewpoints, the aqueous ink composition may contain either one or both of an alkylene glycol ether and an alkanediol having a carbon number of 5 or more.

From the viewpoint of reducing clogging and forming high-quality images, the aqueous ink composition may contain, as an organic solvent, at least one solvent selected from polyols, alkylene glycol ethers, and alkanediols having a carbon number of 5 or more.

The aqueous ink composition may contain only one of the above-cited organic solvents or two or more in combination. If two or more organic solvents are used, the organic solvent content is the total content of the solvents.

The total organic solvent content in the aqueous ink composition may be 13.0% or less, for example, 10.0% or less, 7.0% or less, or 6.0% or less, relative to the total mass of the ink composition. In some embodiments, the total organic solvent content may be 5.0% or less. Such an ink composition is beneficial for producing printed items having high fastness. The lower limit of the organic solvent content may be, by mass, 1.0% or more, for example, 3.0% or more, 5.0% or more. In some embodiments, the lower limit of the organic solvent content may be 6.0% by mass or more. Such an ink composition is beneficial for reducing clogging and obtaining high image quality.

Beneficially, the total content of polyols, alkanediols having a carbon number of 5 or more, and alkylene glycol ethers is within the foregoing range.

Also, it is beneficial to control the content of organic solvents having a normal boiling point of 280° C. or more, beneficially a boiling point in the above-described range, within the foregoing range.

### 1. 2. Water

The aqueous ink composition contains water. “Aqueous” in relation to a composition denotes a composition containing water as one of the major solvents. Water is one of the major solvents of the aqueous ink composition and is a constituent that will be evaporated by drying. Beneficially, the water is pure water or ultra-pure water from which ionic impurities have been removed as much as possible, such as ion-exchanged water, ultrafiltered water, reverse osmosis water, or distilled water. Sterile water prepared by, for example, UV irradiation or addition of hydrogen peroxide may be used. Sterile water can reduce the occurrence of mold or bacteria and the use thereof is beneficial for storing the aqueous ink composition for a long time. The water content may be 50% or more, for example, 70.0% or more, or 75.0% or more, relative to the total mass of the aqueous ink composition. In some embodiments, the water content may be, by mass, in the range of 80.0% to 98% or 85.0% to 95.0%.

### 1. 3. Polymer Particles

The aqueous ink composition disclosed herein may contain polymer particles. The polymer particles may function as a fixing resin that can increase the adhesion and rub-fastness of some components of the aqueous ink composition applied onto the printing medium. Examples of the material of the polymer particles include urethane resin, acrylic resin, fluorene resin, polyolefin resin, rosin-modified resin, terpene resin, polyester resin, polyamide resin, epoxy resin, vinyl chloride resin, and ethylene vinyl acetate resin. The polymer particles are often used in the form of emulsion but may be used in the form of powder. The polymer particles may be composed of a single material or a plurality of materials. Polymer particles may be referred to as resin particles.

Urethane resin is a generic term for resins having a urethane bond. The urethane resin used herein may have other bonds in addition to the urethane bond, and examples of such a urethane rein include a polyether-type urethane resin having an ether bond in the main chain, a polyester-type urethane resin having an ester bond in the main chain, and a polycarbonate-type urethane resin having a carbonate linkage in the main chain. Commercially available urethane resins may be used, and examples thereof include Superflex series 210, 460, 460s, 840, and E-4000 (all produced by Dai-ichi Kogyo Seiyaku), Resamine series D-1060, D-2020, D-4080, D-4200, D-6300, and D-6455 (all produced by Dainichiseika Color & Chemicals Mfg.), Takelac series WS-6020, WS-6021, and W-512-A-6 (all produced by Mitsui Chemicals), Sancure 2710 (produced by Lubrizol), and PERMARIN UA-150 (produced by Sanyo Chemical Industries).

Acrylic resin, which is a generic term for polymers obtained by polymerizing one or more acrylic monomers, such as (meth)acrylic acid and (meth)acrylic acid esters, may be a resin produced from one or more acrylic monomers or a copolymer produced from one or more acrylic monomers and other monomers. Acrylic-vinyl resin, which is a copolymer of an acrylic monomer and a vinyl monomer, is one example of the acrylic resin. More specifically, a copolymer of an acrylic monomer and a vinyl monomer, such as styrene, may be used. Other acrylic monomers include acrylamide and acrylonitrile.

A commercially available acrylic resin emulsion may be used, and examples thereof include FK-854, MOWINYL 952B, and MOWINYL 718A (all produced by Japan Coating Resin), Nipol LX852 and Nipol LX874 (both produced by Nippon Zeon), Polysol AT860 (produce by Showa Denko), and VONCOAT series AN-1190S, YG-651, AC-501, AN-1170, and 4001 (all acrylic emulsions produced by DIC).

The acrylic resin may be a styrene-acrylic resin as mentioned above. The term (meth)acrylic (or (meth)acrylate) used herein refers to at least one of acrylic (or acrylate) and methacrylic (or methacrylate).

Styrene-acrylic resin is a type of copolymer produced from styrene monomers and acrylic monomers, and examples thereof include styrene-acrylic acid copolymers, styrene-methacrylic acid copolymers, styrene-methacrylic acid-acrylate copolymers, styrene-α-methylstyrene-acrylic acid copolymers, and styrene-α-methylstyrene-acrylic acid-acrylate copolymers. Commercially available styrene-acrylic resins may be used, and examples thereof include JONCRYL series 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (all produced by BASF), and MOWINYL series 966A and 975N (both produced by Japan Coating Resin).

The vinyl chloride resin may be a vinyl chloride-vinyl acetate copolymer.

Polyolefin resin is a type of resin having a skeleton containing an olefin, such as ethylene, propylene, or butylene, and a known polyolefin resin may be used. Commercially available polyolefin resins may be used, and examples thereof include ARROWBASE series CB-1200 and CD-1200 (both produced by Unitika).

The polymer particles may be in the form of an emulsion, and commercially available polymer particle emulsions include Micro Gel E-1002 and Micro Gel E-5002 (both styrene-acrylic resin emulsion produced by Nippon Paint); VONCOAT series AN-1190S, YG-651, AC-501, AN-1170, 4001, and 5454 (acrylic resin emulsion produced by DIC); Polysol series AM-710, AM-920, AM-2300, AP-4735, AT-860, and PSASE-4210E (acrylic resin emulsion), Polysol AP-7020 (styrene-acrylic resin emulsion), Polysol SH-502 (vinyl acetate resin emulsion), Polysol series AD-13, AD-2, AD-10, AD-96, AD-17, and AD-70 (ethylene-vinyl acetate resin emulsion), and Polysol PSASE-6010 (ethylene-vinyl acetate resin emulsion), all produced by Showa Denko; Polysol SAE1014 (styrene-acrylic resin emulsion produced by Zeon Corporation); Saivinol SK-200 (acrylic resin emulsion produced by Saiden Chemical Industry); AE-120A (acrylic resin emulsion produced by JSR); AE373D (carboxy-modified styrene-acrylic resin emulsion produced by Emulsion Technology Co., Ltd.); SEIKADYNE 1900W (ethylene-vinyl acetate resin emulsion produced by Dainichiseika Color & Chemicals); VINYBLAN 2682 (acrylic resin emulsion), VINYBLAN 2886 (vinyl acetate-acrylic resin emulsion), VINYBLAN 5202 (acetic acid-acrylic resin emulsion), VINYBLAN 700, and VINYBLAN 2586 (all produced by Nissin Chemical Industry); Elitel series KA-5071S, KT-8803, KT-9204, KT-8701, KT-8904, and KT-0507 (polyester resin emulsion produced by Unitika); Hytec SN-2002 (polyester resin emulsion produced by Toho Chemical Industry); Takelac series W-6020, W-635, W-6061, W-605, W-635, and W-6021 (urethane resin emulsion produced by Mitsui Chemicals); Superflex series 870, 800, 150, 420, 460, 470, 610, 620, and 700 (urethane resin emulsion produced by Dai-ichi Kogyo Seiyaku); PERMARIN UA-150 (urethane resin emulsion produced by Sanyo Chemical Industries); Sancure 2710 (urethane resin emulsion produced by Lubrizol); NeoRez series R-9660, R-9637, and R-940 (urethane resin emulsion produced by Kusumoto Chemicals); ADEKA Bon-Tighter series HUX-380 and 290K (urethane resin emulsion produced by ADEKA); MOWINYL 966A and MOWINYL 7320 (produced by Japan Coating Resin); JONCRYL series 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (produced by BASF); NK Binder R-5HN (produced by Shin-Nakamura Chemical); HYDRAN WLS-210 (non-crosslinked polyurethane produced by DIC); and JONCRYL 7610 (produced by BASF).

The polymer particle content in terms of solids, if added to the aqueous ink composition, may be 0.1% to 20%, for example, 1.0% to 15.0% or 2.0% to 10.0%, relative to the total mass of the aqueous ink composition. In some embodiments, the polymer particle content may be 3.0% to 8.0% by mass.

The aqueous ink composition containing polymer particles is beneficial for producing printed items having high rub-fastness. It is however noted that the polymer particles are dispersed in the ink composition and that the dispersion of the polymer particles should be kept stable. If the stability of the polymer particle dispersion is reduced, the ejection consistency of the ink composition may be reduced. However, the aqueous ink composition disclosed herein can be consistently ejected by being circulated in a printing head having a circulation flow channel, even if the ink composition contains polymer particles.

The material of the polymer particles may be selected from among urethane resin, acrylic resin, polyolefin resin, and polyester resin from the viewpoint of increasing adhesion and rub-fastness.

In particular, urethane resin particles and acrylic resin particles increase the adhesion and the rub-fastness of the aqueous ink composition applied onto the printing medium. In some embodiments, urethane resin particles may be used.

The resin of the polymer particles may have a glass transition temperature Tg of 70° C. or less. Particles of such a resin can easily form coatings, and the coatings exhibit high adhesion and rub-fastness. In addition, from the viewpoint of increasing hardness to enhance rub-fastness and reducing blocking, the glass transition temperature of the polymer particles may be −50° C. or more. Beneficially, the glass transition temperature may be −20° C. or more or −10° C. or more, for example, 0° C. or more, 10.0° C. or more, or 20.0° C. or more. Also, the glass transition temperature may be 50° C. or less or 45.0° C. or less, for example, 40.0° C. or less or 30.0° C. or less.

More specifically, the glass transition temperature may be −20° C. to 60° C., for example, −30° C. to 50° C., 20.0° C. to 50.0° C. or 25.0° C. to 45.0° C. In some embodiments, the glass transition temperature may be 30.0° C. to 40.0° C. The glass transition temperature Tg of the resin of the polymer particles can be measured by, for example, differential scanning calorimetry (DSC).

### 1. 4. Other Constituents

### 1. 4. 1. Coloring Material

The aqueous ink composition may contain a coloring material. The coloring material may be a pigment or a dye and may be selected from among inorganic pigments including carbon black and titanium white, organic pigments, oil dyes, acid dyes, direct dyes, reactive dyes, basic dyes, disperse dyes, and sublimable dyes. The coloring material of the aqueous ink composition disclosed herein may be dispersed with a dispersant resin.

Examples of the inorganic pigments include carbon blacks (C.I. Pigment Black 7), such as furnace black, lamp black, acetylene black, and channel black; iron oxide; titanium oxide; zinc oxide; and silica.

Exemplary organic pigments include quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, isoindolinone pigments, azomethine pigments, and azo pigments.

More specifically, following organic pigments may be used.

Cyan pigments include C.I. Pigment Blues 1, 2, 3, 15:3, 15:4, 15:34, 16, 22, and 60; and C.I. Vat Blues 4 and 60. In some embodiments, at least one selected from among C.I. Pigment Blues 15:3, 15:4, and 60 may be used in the aqueous ink composition.

Magenta pigments include C.I. Pigment Reds 5, 7, 12, 48(Ca), 48(Mn), 57(Ca), 57:1, 112, 122, 123, 168, 184, and 202; and C.I. Pigment Violet 19. In some embodiments, at least one selected from the group consisting of C.I. Pigment Reds 122, 202, and 209 and C.I. Pigment Violet 19 may be used in the aqueous ink composition.

Yellow pigments include C.I. Pigment Yellows 1, 2, 3, 12, 13, 14C, 16, 17, 73, 74, 75, 83, 93, 95, 97, 98, 119, 110, 114, 128, 129, 138, 150, 151, 154, 155, 180, and 185. In some embodiments, at least one selected from the group consisting of C.I. Pigment Yellows 74, 109, 110, 128, and 138 may be used in the aqueous ink composition.

Other color pigments may be used. For example, orange pigments and green pigments may be used.

The above-cited pigments are merely examples and are not intended to limit the subject matter of the disclosure. Pigments may be used independently or in combination and may be used in combination with one or more dyes.

The pigment may be dispersed with a dispersant selected from among water-soluble resins, water-dispersible resins, and surfactants or may be converted into a self-dispersible pigment by surface-oxidation or surface-sulfonation with ozone, hypochlorous acid, fuming sulfuric acid, or the like.

If the pigment is dispersed with a dispersant resin, the ratio of the pigment to the dispersant resin may be 10:1 to 1:10, for example, 4:1 to 1:3. For the particle size of the pigment in dispersion, measured by dynamic light scattering, the largest particle size may be less than 500 nm, and the volume average particle size may be 300 nm or less or 200 nm or less.

Examples of the dye that may be used in the aqueous ink composition include water-soluble dyes, such as acid dyes, direct dyes, reactive dyes, and basic dyes; and water-dispersible dyes, such as dispersible dyes, oil dyes, and sublimable dyes.

These dyes are merely examples and are not intended to limit the subject matter of the disclosure. Dyes may be used independently or in combination and may be used in combination with one or more pigments.

The coloring material content can be adjusted depending on the use of the aqueous ink composition and may be, by mass, 0.10% to 20.0%, for example, 0.20% to 15.0% or 1.0% to 10.0%.

The volume average particle size of the pigment used as the coloring material may be 10.0 nm to 200.0 nm, for example, 30.0 nm to 200.0 nm, 50.0 nm to 150.0 nm, or 70.0 nm to 120.0 nm.

### 1. 4. 2. Surfactant

The aqueous ink composition may contain a surfactant. The surfactant reduces the surface tension of the aqueous ink composition to increase the wettability of the ink composition on the printing medium or the underlying layer. In some embodiments, an acetylene glycol-based surfactant, a silicone surfactant, or a fluorosurfactant may be used.

Examples of the acetylene glycol-based surfactant include, but are not limited to, Surfynol series 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (all produced by Air Products and Chemicals Inc.); Olfine series B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (all produced by Nissin Chemical Industry); and Acetylenol series E00, EOOP, E40, and E100 (all produced by Kawaken Fine Chemical).

The silicone surfactant may be, but is not limited to, a polysiloxane-based compound. For example, a polyether-modified organosiloxane may be used as the polysiloxane-based compound. The polyether-modified organosiloxane is commercially available, and examples thereof include BYK-306, BYK-307, BYK-333, BYK-341, BYK-345, BYK-346, and BYK-348 (all produced by BYK); and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all produced by Shin-Etsu Chemical).

The fluorosurfactant may be a fluorine-modified polymer, and examples thereof include BYK-3440 (produced by BYK), Surflon series S-241, S-242, and S-243 (all produced by AGC Seimi Chemical), and Ftergent 215M (produced by Neos).

Surfactants, if added to the aqueous ink composition, may be used individually or in combination. The content of the surfactant, if added, may be 0.1% to 2.0%, for example, 0.2% to 1.5% or 0.3% to 1.0%, relative to the total mass of the aqueous ink composition.

In the present disclosure, the surfactants cited herein are not regarded as organic solvent.

### 1. 4. 3. pH Adjuster

The aqueous ink composition may contain a pH adjuster. The pH adjuster in the aqueous ink composition suppresses the elution of impurities from a member or component of the ink flow paths or channels and adjusts the cleaning power of the aqueous ink composition. Examples of the pH adjuster include urea compounds, amines, morpholine compounds, piperazine compounds, and amino alcohols, such as triethanolamine. Exemplary urea compounds include urea, ethyleneurea, tetramethylurea, thiourea, 1,3-dimethyl-2-imidazolidinone, and betaines, such as trimethylglycine, triethylglycine, tripropylglycin, triisopropylglycine, N,N,N-trimethylalanine, N,N,N-triethylalanine, N,N,N-triisopropylalanine, N,N,N-trimethylmethylalanine, carnitine, and acetylcarnitine. Exemplary amines include diethanolamine, triethanolamine, and triisopropanolamine.

In the present disclosure, the pH adjusters cited herein are not regarded as organic solvent. For example, triethanolamine, which is liquid and has a normal boiling point of about 208° C. at room temperature, is not regarded as the organic solvent used in the aqueous ink composition.

### 1. 4. 4. Preservative

The aqueous ink composition may contain a preservative.

The use of a preservative reduces the growth of mold and bacteria, and the ink composition can be stably stored. Such an aqueous ink composition can be used as a maintenance liquid that may be used, for example, for maintaining a printer that has not been used for a long time. In an embodiment, the preservative may be selected from among Proxel CRL, Proxel BDN, Proxel GXL, Proxel XL-2, Proxel IB, and Proxel TN.

### 1. 4. 5. Other Constituents

The aqueous ink composition may optionally contain other additives, such as a chelating agent, a corrosion inhibitor, an antifungal agent, an antioxidant, an antireductant, an evaporation promoter, and a water-soluble resin.

Examples of the chelating agent include ethylenediaminetetraacetic acid (EDTA) salts, ethylenediamine nitrilotriacetates, hexametaphosphates, pyrophosphates, and metaphosphates.

### 1. 5. Process for Preparing Aqueous Ink Composition

The aqueous ink composition may be prepared by any process without particular limitation but may be made, for example, by mixing the above-described constituents in any order and, optionally, removing impurities by filtration or the like. For mixing the constituents, for example, the constituents may be added one after another into a container equipped with a stirring device, such as a mechanical stirrer or a magnetic stirrer, and the contents of the container are stirred.

### 1. 6. Physical Properties of Aqueous Ink Composition

The aqueous ink composition of the present disclosure may have a surface tension at 20° C. of 20 mN/m to 40 mN/m, for example, 20 mN/m to 35 mN/m, from the viewpoint of balancing the image quality of the printed item and the reliability of the ink composition used for ink jet printing. The surface tension can be determined by measuring the ink composition wetting a platinum plate at 20° C. with, for example, an automatic surface tensiometer CBVP-Z (manufactured by Kyowa Interface Science).

Also, from the same viewpoint, the ink composition may have a viscosity of 1.0 mPa·s to 20.0 mPa·s, for example, 3.0 mPa·s to 15.0 mPa·s, at 20° C. The viscosity can be measured at 20° C. with, for example, a viscoelasticity meter MCR-300 (manufactured by Pysica).

### 2. Ink Jet Printing Apparatus

The ink jet printing apparatus disclosed herein includes a printing head having a circulation flow channel through which the aqueous ink composition circulates and being operable to eject the above-described aqueous ink composition to apply the aqueous ink composition onto a printing medium. The ink jet printing apparatus is operable to eject the aqueous ink composition and other liquid compositions onto the printing medium from the printing head.

### 2. 1. Outline of Ink Jet Printing Apparatus

An embodiment of the ink jet printing apparatus suitably used for ejecting the aqueous ink composition disclosed herein will now be described with reference to the drawings. For easy recognition, the dimensional proportions of the members or components in the drawing are varied as needed.

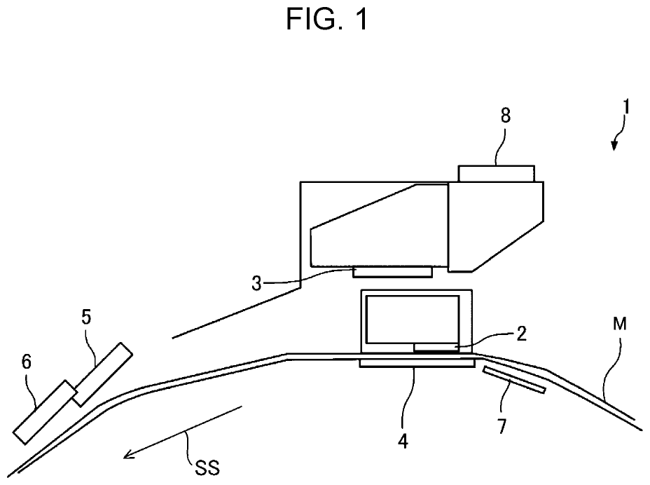

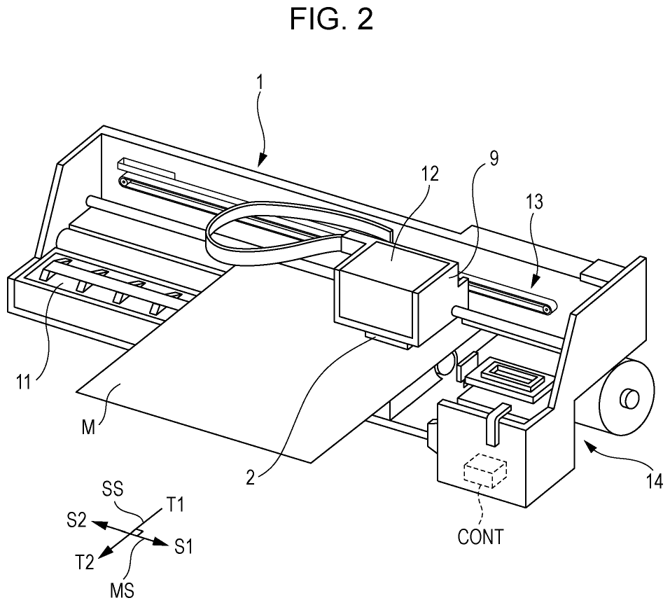

FIG. 1 is a schematic sectional view of an ink jet printing apparatus 1. FIG. 2 is a perspective view illustrating a configuration of the carriage and its vicinity of the ink jet printing apparatus 1 shown in FIG. 1. As shown in FIGS. 1 and 2, the ink jet printing apparatus 1 includes a printing head 2, an IR heater 3, a platen heater 4, a secondary heater 5, a cooling fan 6, a preheater 7, a ventilation fan 8, a carriage 9, a platen 11, a carriage transfer mechanism 13, a transport device 14, and a control unit CONT. The general operation of the ink jet printing apparatus 1 is controlled by the control unit CONT shown in FIG. 2.

The printing head 2 is configured to eject the aqueous ink composition and other liquid compositions through nozzles of the printing head 2, thus applying the ink and ink composition onto a printing medium M. In the embodiment shown in the Figures, the printing head 2 is of a serial type that applies the aqueous ink composition and other liquid compositions onto the printing medium M while scanning the printing medium M in a main scanning direction a plurality of times. The printing head 2 is mounted in the carriage 9 shown in FIG. 2. The printing head 2 is caused to scan the printing medium M in the main scanning direction a plurality of times by the operation of the carriage transfer mechanism 13 that transfers the carriage 9 in the width direction of the printing medium M. The width direction of the printing medium is the main scanning direction in which the printing head 2 scans the printing medium. A pass or movement of the printing head 2 in the main scanning direction may be referred to as main scanning operation.

In the illustrated embodiment, the main scanning direction is a direction in which the carriage 9 equipped with the printing head 2 moves. In FIG. 1, the main scanning direction intersects the sub-scanning direction indicated by arrow SS, which is the direction in which the printing medium M is transported. In FIG. 2, the width direction of the printing medium M, that is, the S1-S2 direction toward either side, is the main scanning direction MS, and the T1→T2 direction is the sub-scanning direction SS. When the printing head 2 scans the printing medium once, the printing head 2 moves in one of the directions indicated by arrows S1 and S2. By repeating such main scanning operation of the printing head 2 and transport of the printing medium M in the sub-scanning direction, printing is performed on the printing medium M. In other words, the aqueous ink composition is applied by plural times of the main scanning operation of the printing head 2 moving in the main scanning directions and plural times of the transport of the printing medium M (sub-scanning operation) in the sub-scanning direction intersecting the main scanning direction.

A cartridge set 12 operable to feed the aqueous ink composition and other liquid compositions to the printing head 2 includes a plurality of cartridges independent of each other. The cartridge set 12 is removably mounted on the carriage 9 equipped with the printing head 2. Each of the cartridges contains a different type of aqueous ink composition or any other composition, and the ink compositions and other compositions are fed to the nozzles from the respective cartridges. Although in the illustrated embodiment, the cartridge set 12 is mounted on the carriage 9, the cartridge set or cartridges of an embodiment may be disposed at a position other than the carriage 9 so that the ink compositions or other compositions can be fed to the nozzles through a feed tube (not shown).

Ejection from the printing head 2 may be performed by a known technique. In the present embodiment, the printing head 2 ejects droplets in response to vibration of piezoelectric elements, that is, ejects droplets formed by mechanical deformation of electrostrictive elements.

The ink jet printing apparatus 1 may include a drying mechanism operable to dry the printing medium M when the aqueous ink composition is applied onto the printing medium M by ejection from the printing head 2. Heating or blowing may be performed for drying. The drying mechanism may be based on heat conduction, blowing, heat radiation, or the like. Heat conduction-type drying mechanism conducts heat to the printing medium from a member in contact with the printing medium. A platen heater is an example of the heat conduction type. A blowing-type drying mechanism blows normal-temperature air or warm air on the printing medium to dry the ink composition. A blowing fan is an example of the blowing type. A heat-radiation type drying mechanism radiates heat-generating radiation to dry the printing medium. An IR heater is an example of the heat-radiation type. These drying mechanisms may be used individually or in combination.

In an embodiment, the drying mechanism includes an IR heater 3 and a platen heater 4. In a drying operation for drying the printing medium M, an IR heater 3, a ventilation fan 8, or the like may be used.

The IR heater 3 is operable to heat the printing medium M by emitting infrared radiation from the side on which the printing head 2 is located. The IR heater is likely to heat the printing head 2 simultaneously with the printing medium M but can increase the temperature of the printing medium M without the thickness of the printing medium M having any effect, unlike the case of the platen heater 4 that heats the printing medium M from the rear side. A fan (for example, the ventilation fan 8) may be provided for applying warm air or air having the same temperature as the ambient temperature to the printing medium M to dry the aqueous ink compositions and other liquid compositions on the printing medium M.

The platen heater 4 can heat the printing medium M with the platen 11 therebetween, at a position opposite the printing head 2, to dry the ink composition ejected from the printing head 2 immediately after the ink composition has been applied onto the printing medium M. The platen heater 4, which heats the printing medium M by conduction, is optional in the ink jet printing. In an embodiment using the platen heater 4, the surface temperature of the printing medium M may be controlled to 45.0° C. or less. The platen heater 4 corresponds to an under-heater used in a line ink jet printing apparatus described later herein. If a drying step with a drying mechanism is not performed, the drying mechanism is not necessarily provided.

The upper limit of the surface temperature of the printing medium M onto which the ink composition is being applied in the drying step using a drying mechanism may be 45.0° C. or less, for example, 40.0° C. or less, 38.0° C. or less, or 35.0° C. or less. Also, the lower limit of the surface temperature of the printing medium M may be 25.0° C. or more, for example, 28.0° C. or more, 30.0° C. or more, or 32.0° C. or more. In such conditions, the aqueous ink composition in the printing head 2 is unlikely to dry or deteriorate, and the ink composition or the resin therein is unlikely to adhere to the inner wall of the printing head 2. Also, the aqueous ink composition and other liquid compositions can be rapidly fixed, thus reducing image transfer to the rear side of the printing medium and improving image quality.

In an embodiment of the ink jet printing method, post-application heating may be performed heating the printing medium to dry and fix the ink composition. This step may be referred to as the secondary heating.

The secondary heater 5 used in the secondary heating is operable to dry or solidify the ink composition applied onto the printing medium M, that is, acts as an auxiliary heater or dryer. The secondary heater 5 is used for post-application heating. The secondary heater 5 heats the image printed on the printing medium M to rapidly evaporate water or any other solvent from the aqueous ink composition in the image, and, consequently, the resin remaining in the aqueous ink composition forms an ink coating film. Thus, the ink coating film is firmly fixed or adheres to the printing medium M, thus forming a high-quality image in a short time.

The upper limit of the surface temperature of the printing medium M heated by the secondary heater 5 may be 120.0° C. or less, for example, 100.0° C. or less or 90.0° C. or less. Also, the lower limit of the surface temperature of the printing medium M at this time may be 60.0° C. or more, for example, 70.0° C. or more or 80.0° C. or more. By controlling the surface temperature of the printing medium in such a range, high-quality images can be formed in a short time. The secondary heater 5 corresponds to an after-heater used in a line ink jet printing apparatus described later herein and may be implemented as a carbon heater or the like.

The ink jet printing apparatus 1 may include a cooling fan 6. By cooling the aqueous ink composition applied onto the printing medium M with the cooling fan 6 after drying, the ink composition can form an ink coating film on the printing medium M with high adhesion.

The ink jet printing apparatus 1 may also include a preheater 7 operable to previously heat the printing medium M before the aqueous ink composition is applied onto the printing medium M. Furthermore, the ink jet printing apparatus 1 may include the ventilation fan 8 operable to efficiently dry the aqueous ink composition and other liquid compositions on the printing medium M. In the line ink jet printing apparatus described later herein, the platen heater 7 may be provided.

Below the carriage 9 are disposed a platen 11 on which the printing medium M is supported, a carriage transfer mechanism 13 operable to transfer the carriage 9 relative to the printing medium M, and a transport device 14 that is a roller operable to transport the printing medium M in the sub-scanning direction. The control unit CONT controls the operations of the carriage transfer mechanism 13 and the transport device 14.

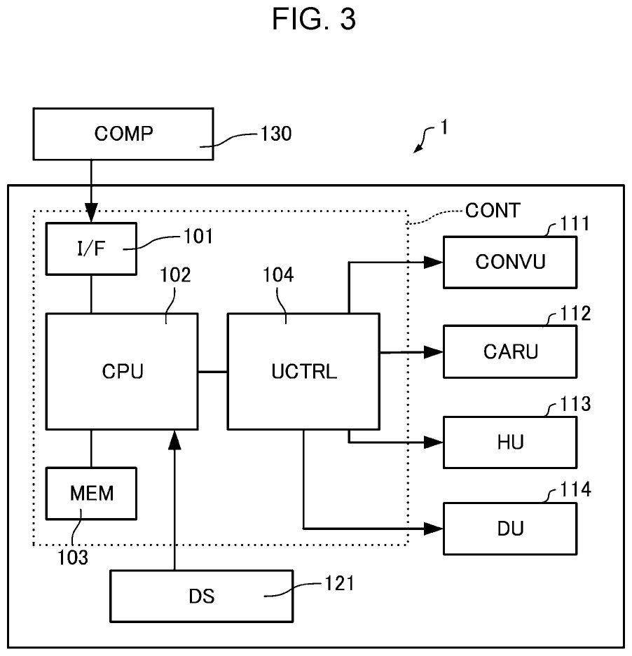

FIG. 3 is a functional block diagram of the ink jet printing apparatus 1. The control unit CONT is operable to control the ink jet printing apparatus 1. An interface (I/F) 101 enables data communication between the computer (COMP) 130 and the ink jet printing apparatus 1. A CPU 102 is an arithmetic processing unit configured to control the general operation of the printing apparatus 1. A memory device (MEM) 103 secures a storage in which the program of the CPU 102 is stored and a region in which the CPU 102 works. The CPU 102 causes a unit control circuit (UCTRL) 104 to control various units. Detectors (DS) 121 monitor the interior of the ink jet printing apparatus 1. The control unit CONT controls each unit according to the monitoring results of the detectors.

A transport unit (CONVU) 111 controls transporting operation in ink jet printing, that is, the direction and the speed of the transport of the printing medium. More specifically, the transport direction and speed of the printing medium M are controlled by controlling the rotational direction and speed of the transport roller driven by a motor.

A carriage unit (CARU) 112, which is operable to control the main scanning operation (passes) for ink jet printing, reciprocally moves the printing head 2 in the main scanning direction. The carriage unit 112 includes the carriage 9 equipped with the printing head 2, and the carriage transfer mechanism 13 operable to reciprocally move the carriage 9.

A head unit (HU) 113 is operable to control the amount of the aqueous ink composition or any other liquid composition ejected through the nozzles of the printing head 2. For example, if piezoelectric elements drive the ejection through the nozzles of the printing head 2, the head unit 113 controls the operation of the piezoelectric elements for the nozzles. The head unit 113 controls the application timing, the dot size, and the like of the ink composition and other liquid compositions. In addition, a combination of controls for the carriage unit 112 and the head unit 113 can control the amounts of the aqueous ink composition and other liquid compositions applied during one scanning operation.

A drying unit (DU) 114 is operable to control the temperatures of heaters, such as the IR heater 3, the preheater 7, the platen heater 4, and the secondary heater 5.

The ink jet printing apparatus 1 alternately repeats the main scanning operation of moving the carriage 9 equipped with the printing head 2 in the main scanning direction and the operation of transporting the printing medium (sub-scanning operation). For each pass, or main scanning operation, at this time, the control unit CONT controls the carriage unit 112 to move the printing head 2 in the main scanning direction and also controls the head unit 113 to eject droplets of the aqueous ink composition and other liquid compositions through predetermined nozzle openings of the printing head 2, thus applying droplets of the ink composition and other liquid compositions onto the printing medium M. The control unit CONT also controls the transport unit 111 to transport the printing medium M in a predetermined degree of transport in the transporting direction.

In the ink jet printing apparatus 1, a printing region on which a plurality of droplets have been applied is gradually transported by alternately repeating the main scanning operation (pass) and the sub-scanning operation (medium transport). Then, the droplets on the printing medium M are dried with an after-heater 5 to complete an image. The completed printed item may be then wound into a roll by a winding mechanism or transported by a flatbed mechanism.

### 2. 2. Printing Head Having Circulation Flow Channel

The aqueous ink composition according to an embodiment of the present disclosure may be ejected from a printing head having a circulation flow channel for at least the aqueous ink composition. In other words, at least the aqueous ink composition circulates through the circulation flow channel. The circulation flow channel has a route that causes the aqueous ink composition to pass through the pressure chamber and return to the pressure chamber.

The printing head 2 disclosed herein has a circulation flow channel through which the aqueous ink composition circulates. Even if the solute content of the aqueous ink composition is partially increased by drying, the thickened portion of the aqueous ink composition flows back upstream through the circulation flow channel and mixes with an unthickened portion of the aqueous ink composition. Thus, the circulation flow channel maintains consistent ejection of the aqueous ink composition.

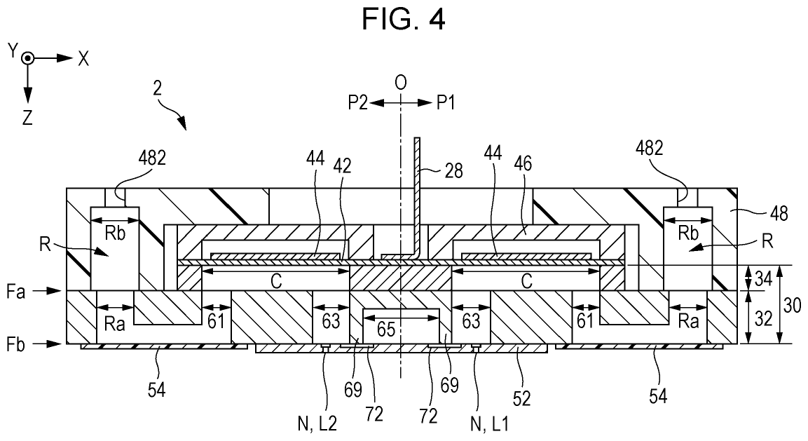

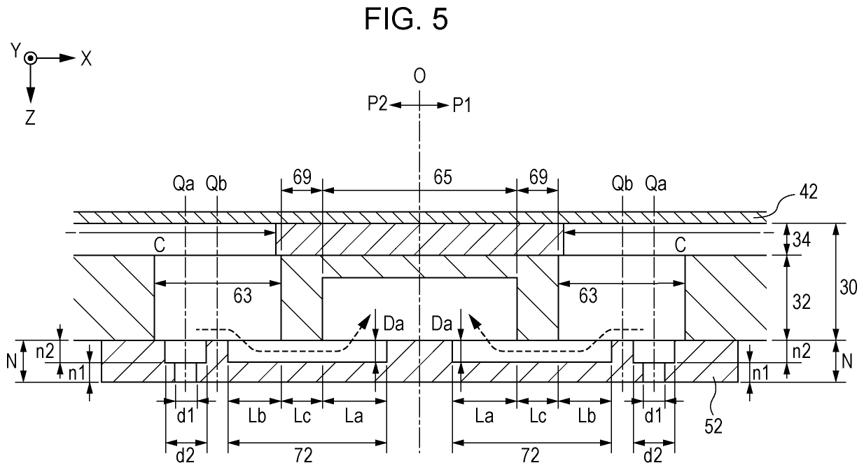

FIG. 4 is a schematic sectional view of a printing head 2 taken in a direction perpendicular to the Y direction in which the printing medium M is transported (the sub-scanning direction SS in FIG. 2), and FIG. 5 is schematic sectional view of the circulation chamber and vicinity of the printing head 2. In FIGS. 4 and 5, the plane parallel to the surface of the printing medium is defined as the X-Y plane, and a direction perpendicular to the X-Y plane is defined as the Z direction. The direction in which the printing head 2 ejects the aqueous ink composition corresponds to the Z direction.

A plurality of nozzles N of the printing head 2 are aligned in the Y direction. In the following description, the plane that passes through the central axis parallel to the Y direction of the printing head 2 and that is parallel to the Z direction, that is, the Y-Z plane O, is referred to as the “central plane”.

As shown in FIG. 4, the printing head 2 has nozzles N in a first line L1 and nozzles N in a second line L2, and components or members associated with the nozzles N in the first line L1 and components or members associated with the nozzles N in the second line L2 are symmetrically arranged with respect to the central plane O. The portion of the printing head 2 on the positive side of the central plane O in the X-direction (hereinafter referred to as the first portion P1), and the portion on the negative side in the X direction (hereinafter referred to as the second portion P2) have substantially the same structure. The nozzles N in the first line L1 are formed in the first portion P1, and the nozzles N in the second line L2 are formed in the second portion P2. The central plane O is the boundary between the first portion P1 and the second portion P2.

In the embodiment illustrated in FIG. 4, the nozzles N in the second line L2 and the nozzles N in the first line L1 define nozzle lines 15a (see FIG. 4) to be filled with the aqueous ink composition. The region of the printing head operable to eject the aqueous ink composition (nozzle lines 15b to 5f (see FIG. 4) to be filled with the aqueous ink composition), which is not described here, may have the same structure.

As shown in FIG. 4, the printing head 2 has a flow path portion 30. The flow path portion 30 is a structure in which flow paths through which the aqueous ink composition is fed to the plurality of nozzles N are formed. In the illustrated embodiment, the flow path portion 30 includes two layers: a first flow path substrate 32 and a second flow path substrate 34. The first flow path substrate 32 and the second flow path substrate 34 are each a plate member that is long in the Y direction. The second flow path substrate 34 is disposed with, for example, an adhesive on the surface Fa of the first flow path substrate 32 on the negative side in the Z direction.

As shown in FIG. 4, the first flow path substrate 32 is provided, at the surface Fa thereof, with a vibration member 42, piezoelectric elements 44, a protection member 46, and a housing 48, in addition to the second flow path substrate 34. On the positive side in the Z direction of the first flow path substrate 32, that is, on the surface Fb opposite the surface Fa, a nozzle plate 52 and an absorber 54 are disposed. The members or components of the printing head 2 are generally long in the Y direction, as well as the first flow path substrate 32 and the second flow path substrate 34, and are bonded together with, for example, an adhesive. The Z direction may be considered to be the direction in which the first flow path substrate 32 and the second flow path substrate 34 are stacked, the direction in which the first flow path substrate 32 and the nozzle plate 52 are stacked, or the direction perpendicular to the surfaces of various plate members.

The nozzle plate 52 is a plate member having a plurality of nozzles N therein and is disposed on the surface Fb of the first flow path substrate 32 with, for example, an adhesive. Each of the nozzles is a circular through-hole through which the aqueous ink composition passes. The nozzle plate 52 has nozzles N defining the first line L1 and nozzles N defining the second line L2. More specifically, the nozzles N in the first line L1 are aligned in the Y direction on the positive side in the X direction of the nozzle plate 52 with respect to the central plane O, and the nozzles N in the second line L2 are aligned in the Y direction on the negative side in the X direction of the nozzle plate 52. The nozzle plate 52 is a continuous one-piece plate member having both the nozzles N in the first line L1 and the nozzles N in the second line L2. The nozzle plate 52 is formed of a monocrystalline silicon substrate by a semiconductor processing technology, such as dry etching or wet etching. The nozzle plate 52 may be formed by using any other known material and process.

As shown in FIG. 4, the first flow path substrate 32 has a space Ra, a plurality of feed paths 61, and a plurality of communication paths 63 in both the first portion P1 and the second portion P2. The space Ra is an opening having a rectangular shape that is long in the Y direction when viewed in the Z direction, and the feed paths 61 and the communication paths 63 are through-holes formed individually for the nozzles N. The communication paths 63 are aligned in the Y direction when viewed from above, and the feed paths 61 are aligned in the Y direction between the alignment of the communication paths 63 and the space Ra. The feed paths 61 communicate with and share the space Ra. Any one of the communication paths 63 is coincident in position with the corresponding nozzle N when viewed from above. More specifically, any one of the communication paths 63 in the first portion P1 communicates with the corresponding nozzle N in the first line L1. Similarly, any one of the communication paths 63 in the second portion P2 communicates with the corresponding nozzle N in the second line L2.

As shown in FIG. 4, the second flow path substrate 34 is a plate member having a plurality of pressure chambers C in each of the first portion P1 and the second portion P2. The pressure chambers C in each portion are arranged in the Y direction. The pressure chambers C are provided one for each nozzle N and are each a space that is long in the X direction when viewed from above. As with the nozzle plate 52, the first flow path substrate 32 and the second flow path substrate 34 are, for example, formed of a monocrystalline silicon substrate by a semiconductor processing technology. The first flow path substrate 32 and the second flow path substrate 34 may be formed by using any other known material and process. In the disclosed embodiment, the flow path portion 30 and the nozzle plate 52 include a substrate made of silicon, as described above. Silicon substrates are beneficial in forming the flow path portion 30 and nozzle plate 52 having fine and precise flow paths by semiconductor processing.

As shown in FIG. 4, the second flow path substrate 34 is provided with a vibration member 42 on the surface thereof opposite the first flow path substrate 32. The vibration member 42 is an elastic plate capable of vibrating. In an embodiment, the second flow path substrate 34 and the vibration member 42 may be formed in a one-piece body whose thickness is selectively reduced corresponding to the positions of the pressure chambers C.

The surface Fa of the first flow path substrate 32 and the vibration member 42 oppose each other with the spaces of the pressure chambers C therebetween, as shown in FIG. 4. The pressure chambers C, which are spaces formed between the surface Fa of the first flow path substrate 32 and the vibration member 42, cause the aqueous ink composition in the spaces to vary in pressure. The pressure chambers C are each a space that is, for example, long in the X direction and are formed individually, one for each nozzle N. The pressure chambers C are arranged in the Y direction for each of the first line L1 and the second line L2.

As shown in FIG. 4, one end adjacent to the central plane O of any one of the pressure chambers C is aligned with the corresponding communication path 63 when viewed from above, and the other end, remote from the central plane O, is aligned with the corresponding feed path 61 when viewed from above. Thus, the pressure chambers C communicate with the nozzles N through the communication paths 63 and communicate with the space Ra through the feed paths 61 in each of the first portion P1 and the second portion P2. In an embodiment, partially narrowed flow paths may be formed in the pressure chambers C to give the ink composition a predetermined flow resistance.

A plurality of piezoelectric elements 44 are provided on the surface of the vibration member 42 opposite the pressure chambers C individually for the nozzles N in each of the first portion P1 and the second portion P2, as shown in FIG. 4. The piezoelectric elements 44 are elements that deform according to the driving signals transmitted thereto. The piezoelectric elements 44 are arranged in the Y direction, corresponding to the pressure chambers C. Any one of the piezoelectric elements 44 is a multilayer composite that, for example, includes two electrodes with a piezoelectric layer therebetween. Alternatively, portions that deform according to the driving signals applied thereto, that is, active portions that vibrate the vibration member 42, may define piezoelectric elements 44. In the illustrated embodiment, when the vibration member 42 vibrates in conjunction with the deformation of the piezoelectric elements 44, the pressure in the pressure chambers C varies, and thus, the aqueous ink composition in the pressure chambers C is ejected through the communication paths 63 and the nozzles N.

The protection member 46 shown in FIG. 4 is a plate member configured to protect the plurality of piezoelectric elements 44 and is disposed on the surface of the vibration member 42 or the surface of the second flow path substrate 34. The protection member 46 may be formed of any material by any method but may be formed in the same manner as in the case of the first flow path substrate 32 and the second flow path substrate 34, for example, by semiconductor processing of a monocrystalline silicon substrate. The piezoelectric elements 44 arranged in the Y direction are accommodated individually in the recesses formed in the surface, adjacent to the vibration member 42, of the protection member 46.

A terminal of a wiring board 28 is joined to the surface, opposite the flow path portion 30, of the vibration member 42 or the surface of the flow path portion 30. The wiring board 28 is a flexible component having a plurality of conducting wires (not shown) that electrically couple a control unit to the printing head 2. A terminal of the wiring board 28 is extracted through an opening of the protection member 46 and an opening of the housing 48 and coupled to a control unit. A flexible wiring board, such as a flexible printed circuit (FPC) or a flexible flat cable (FFC) may be used as the wiring board 28.

The housing 48 is a case adapted to hold the aqueous ink composition to be fed to the pressure chambers C and further to the nozzles N. The surface of the housing 48 on the positive side in the Z direction is bonded to the surface Fa of the first flow path substrate 32 with, for example, an adhesive. The housing 48 may be formed by using any known material and process. For example, the housing 48 may be formed by injection molding of a resin material.

As shown in FIG. 4, the housing 48 has a space Rb in each of the first portion P1 and the second portion P2. The space Rb of the housing 48 and the space Ra of the first flow path substrate 32 communicate with each other. The space Ra and the space Rb define a space that acts as a liquid reservoir R from which the aqueous ink composition is fed to the pressure chambers C. The liquid reservoir R is a common ink chamber shared by the plurality of nozzles N. Each of the first portion P1 and the second portion has the liquid reservoir R. The liquid reservoir R in the first portion P1 is located on the positive side in the X direction with respect to the central plane O, and the liquid reservoir R in the second portion P2 is located on the negative side in the X direction with respect to the central plane O. The housing 48 has inlets 482 in the surface thereof opposite the first flow path substrate 32. The aqueous ink composition fed from a liquid container is introduced into the liquid reservoirs R through the respective inlets 482.

As shown in FIG. 4, a vibration absorber 54 is disposed on the surface Fb of the first flow path substrate 32 in each of the first portion P1 and the second portion P2. The vibration absorber 54 is a flexible film that absorbs pressure changes of the aqueous ink composition in the liquid reservoir R, thus being a compliance substrate. The vibration absorber 54 may be disposed, for example, on the surface Fb of the first flow path substrate 32 to close the space Ra and feed paths 61 of the first flow path substrate 32, thus defining a wall, more specifically, the bottom, of the reservoir R.

As shown in FIG. 4, the first flow path substrate 32 has a space (hereinafter referred to as a liquid circulation chamber) 65 in the surface Fb thereof opposing the nozzle plate 52. The liquid circulation chamber 65 of the illustrated embodiment is an opening with a bottom that is long in the Y direction when viewed from above. The open end of the liquid circulation chamber 65 is closed by the nozzle plate 52 joined to the surface Fb of the first flow path substrate 32. The liquid circulation chamber 65 extends, for example, along the first line L1 and the second line L2 of the nozzles N. More specifically, the liquid circulation chamber 65 is formed between the alignment of the nozzles N in the first line L1 and the alignment of the nozzles N in the second line L2. Thus, the liquid circulation chamber 65 lies between the communication paths 63 in the first portion P1 and the communication paths 63 in the second portion P2. Thus, the flow path portion 30 is a structure having the pressure chambers C and the communication paths 63 in the first portion P1, the pressure chambers C and the communication paths 63 in the second portion P2, and the liquid circulation chamber 65 between the arrangement of the communication paths 63 in the first portion P1 and the arrangement of the communication paths 63 in the second portion P2. The flow path portion 30 has a wall (hereinafter referred to as a partition) 69 to separate the liquid circulation chamber 65 from the communication paths 63, as shown in FIG. 4.

In each of the first portion P1 and the second portion P2, a plurality of piezoelectric elements 44, as well as the pressure chambers C, are arranged in the Y direction. Thus, the liquid circulation chamber 65 extends continuously in the Y direction along the arrangement of the pressure chambers C or the piezoelectric elements 44 in each of the first portion P1 and the second portion P2. In other words, the liquid circulation chamber 65 and the liquid reservoir R extend in the Y direction apart at a distance, and the pressure chambers C, the communication paths 63, and the nozzles N are located within the distance, as shown in FIG. 4.

FIG. 5 is a fragmentary enlarged sectional view of the printing head 2, illustrating the liquid circulation chamber 65 and vicinity. As shown in FIG. 5, the individual nozzles N have a first zone n1 and a second zone n2. The first zone n1 and the second zone n2 are coaxial cylindrical spaces communicating with each other. The second zone n2 is closer than the first zone n1 to the flow path portion 30. In the illustrated embodiment, the central axis Qa of each nozzle N is opposite to the liquid circulation chamber 65 with respect to the central axis Qb of the communication path 63. The inner diameter d2 of the second zone n2 is larger than the inner diameter d1 of the first zone n1. Nozzles in such a step form are advantageous for controlling the flow resistance in each nozzle N as desired.

As shown in FIG. 5, the nozzle plate 52 is provided in each of the first portion P1 and the second portion P2 with a plurality of discharge paths 72 in the surface thereof opposing the flow path portion 30. The discharge paths 72 in the first portion P1 correspond one-to-one to the nozzles N in the first line L1 or the communication paths 63 corresponding to the first line L1. Similarly, the discharge paths 72 in the second portion P2 correspond one-to-one to the nozzles N in the second line L1 or the communication paths 63 corresponding to the second line L2.

In the printing head disclosed herein, a flow path through which ink enters a route and a flow path through which the ink discharges from the route define together a circulation flow channel. The ink-discharging flow path causes the ink to deviate from the main route through which ink fed into the printing head flows until being ejected through a nozzle. The ink-entering flow path allows the ink discharged from the main route to re-enters the main route. The ink-entering flow path may be a part of the main route. In other words, the ink-entering flow path can be a flow path through which the ink outside the main route returns to the main route.

For example, in the embodiment illustrated in FIG. 4, at least the feed path 61 and the discharge path 72 define the circulation flow channel. The circulation flow channel provides a route through which a liquid to be ejected through a nozzle N fed through the feed path 61 deviates from a main route from the feed path 61 to the nozzle N without being ejected through the nozzle and returns to the main route.

Each discharge path 72 is a ditch, or opening with a bottom, that is long in the X direction, functioning as a flow path through which the aqueous ink composition flows. The discharge path 72 has a distance from the corresponding nozzle N and is closer than the nozzle N to the liquid circulation chamber 65. The discharge path 72 is formed by, for example, a process using semiconductor technology, such as dry etching or wet etching, together with the nozzles N, particularly the second zone n2, in the same process at one time.

The discharge path 72 is linear and has a width equal to the inner diameter d2 of the second zone n2 of the nozzle N. The width, in the Y direction, of the discharge path 72 is smaller than the width, in the Y direction, of the pressure chamber C. Such a structure increases the flow resistance in the discharge path 72 compared to the structure in which the width of the discharge path 72 is larger than the width of the pressure chamber C. In an embodiment, however, the discharge path 72 may be formed with a larger width than the pressure chamber C. The depth Da of the discharge path 72 from the surface of the nozzle plate 52 is constant throughout the length of the discharge path 72. In the illustrated embodiment, the discharge path 72 has a depth equal to the depth of the second zone n2 of the nozzle N. In an embodiment, the discharge path 72 and the second zone n2 may have different depths. It is, however, easier to form the discharge path 72 and the second zone n2 to the same depth. The depth of a flow path refers to the measurement in the Z direction of the flow path, that is, the difference in level between the open end and the bottom of the flow path.

Any one of the discharge paths 72 in the first portion P1 lies closer than the corresponding nozzle N to the liquid circulation chamber 65. Similarly, any one of the discharge paths 72 in the second portion P2 lies closer than the corresponding nozzle N to the liquid circulation chamber 65. The end, remote from the central plane O, of each discharge path 72 lies within the region defined by the corresponding communication path 63 when viewed from above. Hence, the discharge path 72 communicates with the communication path 63. On the other side, the end adjacent to the central plane O of the discharge path 72 lies within the region defined by the liquid circulation chamber 65 when viewed from above. Hence, the discharge path 72 communicates with the liquid circulation chamber 65. As described above, each of the communication paths 63 communicates with the liquid circulation chamber 65 through the corresponding discharge path 72. Thus, the aqueous ink composition in each communication path 63 is fed to the liquid circulation chamber 65 through the discharge path 72, as indicated by the broken lines with an arrowhead in FIG. 5. In other words, in the illustrated embodiment, the communication paths 63 corresponding to the nozzles N in the first line L1 and the communication paths 63 corresponding to the nozzles N in the second line L2 share and communicate with the single liquid circulation chamber 65.

In FIG. 5, any one of the discharge paths 72 has a portion with a length La overlapping with the liquid circulation chamber 65, a portion with a length Lb in the X direction overlapping with the communication path 63, and a portion with a length Lc in the X direction overlapping with the partition 69 of the flow path portion 30. Length Lc is equivalent to the thickness of the partition 69. The partition 69 acts as a throttle of the ejection path 72. Accordingly, the longer the length Lc corresponding to the thickness of the partition 69, the larger the flow resistance in the discharge path 72. Although the relationship between length La and length Lc can be set as desired, length La, in the illustrated embodiment, is larger than length Lb and length Lc. In the illustrated embodiment, furthermore, length Lb is larger than length Lc. In such a structure, the aqueous ink composition can be easily introduced into the liquid circulation chamber 65 from the communication path 63 through the discharge path 72 compared to the structure in which length La and length Lb are shorter than length Lc.

In the printing head 2, the pressure chambers C communicate indirectly with the liquid circulation chamber 65 through the communication paths 63 and the discharge paths 72, as described above. Hence, the pressure chambers C do not communicate directly with the liquid circulation chamber 65. In such a structure, as any one of the piezoelectric elements 44 operates to change the pressure in the corresponding pressure chamber C, a portion of the aqueous ink composition flowing in the communication path 63 is ejected through the nozzle N, and a portion of the rest of the aqueous ink composition flows into the liquid circulation chamber 65 from the communication path 63 through the discharge path 72. The inertances in the communication path 63, the nozzle N, and the discharge path 72 are determined so that the amount (ejection amount) of the aqueous ink composition ejected from the communication path 63 through the nozzle N by one operation of the piezoelectric element 44 is larger than the amount (circulation amount) of the aqueous ink composition flowing into the liquid circulation chamber 65 from the communication path 63 through the discharge path 72. In other words, if all the piezoelectric elements 44 operate at one time, the total circulation amount of the ink composition flowing into the liquid circulation chamber 65 from the plural communication paths 63, for example, the amount per unit time of the ink composition flowing in the liquid circulation chamber 65, is larger than the total ejection amount of the ink composition ejected through the plural nozzles N.

More specifically, the flow resistance in each of the communication path 63, the nozzle N, and the discharge path 72 is determined so that the amount of the aqueous ink composition to circulate can account for 70% or more (or the amount of the aqueous ink composition to be ejected can account for 30% or less) of the amount of the aqueous ink composition flowing in the communication path 63. In such a structure, the aqueous ink composition in the vicinity of the nozzles can be conducted effectively into the ink circulation chamber 65 with a sufficient ejection amount ensured. Broadly speaking, as the flow resistance in the discharge path 72 is increased, the circulation amount decreases, whereas the ejection amount increases; and as the flow resistance in the discharge path 72 is reduced, the circulation amount increases, whereas the ejection amount decreases.

In an embodiment, for example, the ink jet printing apparatus 1 may include a circulation mechanism (not shown). The circulation mechanism is configured to feed the aqueous ink composition in the liquid circulation chamber 65 to the liquid reservoirs R, that is, configured to circulate the ink composition. The circulation mechanism includes a suction mechanism, such as a pump, that sucks the aqueous ink composition from the liquid circulation chamber 65, a filter mechanism (not shown) operable to remove air bubbles and foreign matter from the aqueous ink composition, and a heating mechanism operable to heat the aqueous ink composition to reduce the thickening of the aqueous ink composition. After air bubbles and foreign matter have been removed while the thickening is reduced, the aqueous ink composition is fed to the liquid reservoirs R from the circulation mechanism through the respective inlets 482. Thus, the aqueous ink composition is circulated in the following order: the liquid reservoirs R, the feed paths 61, the pressure chambers C, the communication paths 63, the discharge paths 72, the liquid circulation chamber 65, the circulation mechanism, and the liquid reservoirs R. In other words, the circulation flow channel has a route to cause the aqueous ink composition to pass through the pressure chamber and return to the pressure chamber C.

In such a structure that the discharge paths 72 connecting the communication paths 63 to the liquid circulation chamber 65 are formed in the nozzle plate 52, the aqueous ink composition in the vicinity of the nozzles N can efficiently enter the liquid circulation chamber 65 for circulation. Also, in the illustrated embodiment, the communication paths 63 corresponding to the nozzles in the first line L1 and the communication paths 63 corresponding to the nozzles in the second line L2 communicate with and share the liquid circulation chamber 65 disposed therebetween. In such a structure, the printing head 2 can be simplified in structure and thus downsized compared to a structure in which a liquid circulation chamber communicating with the discharge paths 72 corresponding to the nozzles in the first line L1 and a liquid circulation chamber communicating with the discharge paths 72 corresponding to the nozzles in the second line L2 are individually provided.

In an embodiment, the discharge paths 72 and the corresponding nozzles N may be continuously connected without separation. In an embodiment, additional liquid circulation chambers, other than the illustrated liquid circulation chamber 65, may be provided for each of the first portion P1 and the second portion P2.

The amount of aqueous ink composition flowing in the circulation flow channels may be controlled to a proportion in the range of 0.1 to 5.0, for example, 0.2 to 4.0, 0.3 to 3.0, or 0.5 to 2.0, relative to the maximum ejection amount of aqueous ink composition ejected onto the printing medium from the printing head. Such a proportion of the circulation amount to the ejection amount of the aqueous ink composition is in balance, and, in such a proportion, the aqueous ink composition can be sufficiently applied onto the printing medium while efficiently resisting drying or thickening.

The maximum ejection amount of the aqueous ink composition is the maximum amount of a droplet of the aqueous ink composition ejected by one printing ejection. For example, if the aqueous ink composition is ejected through all the nozzles for printing at a maximum ejection frequency, the amount of the aqueous ink composition ejected from the printing head is the maximum ejection amount.

The amount of the aqueous ink composition flowing in the circulation flow channel is the total amount of the aqueous ink composition flowing through the discharge paths connecting to the nozzles of the printing head.

The maximum ejection amount of the aqueous ink composition and the amount of the aqueous ink composition flowing through the circulation flow channel are represented by “mass/unit time”, for example, “g/s”. The same applies to other liquid compositions. The circulation amount per printing head of the aqueous ink composition may be 1.0 g/min to 12.0 g/min, for example, 2.0 g/min to 10.0 g/min or 3.0 g/min to 7.0 g/min. In this instance, “per printing head” implies a unit defined by all nozzles through which the ink introduced through one inlet is ejected. The number of nozzles in a unit printing head may be, bit is not limited to, from 50 to 1000, for example, 100 to 700, 150 to 500, or 200 to 400.

The printing head 2, which includes pressure chambers C operable to apply a pressure to the aqueous ink composition to eject the ink composition through the corresponding nozzles, may be configured so that the aqueous ink composition that has passed through the pressure chambers C can circulate through the circulation flow channels as in the embodiment illustrated in FIG. 4. The aqueous ink composition that has passed through the pressure chambers C is circulated and returned to the pressure chambers. In this instance, the discharge paths are disposed at the pressure chambers or downstream from the pressure chambers. Such a structure provides favorable ejection consistency.

In an embodiment, the circulation flow channel may have the discharge path at a position upstream from the pressure chamber in the printing head to discharge the aqueous ink composition for circulation. The aqueous ink composition thus circulated may return to that position. In this instance, the ink composition is circulated before being introduced into the pressure chamber. This structure can remove foreign matter and reduce the viscosity of the ink composition if the ink composition is contaminated with foreign matter or thickened upstream from the pressure chamber, thus increasing the ejection consistency of the ink composition. The upstream position at which the discharge path is provided may be at the liquid reservoir R.

The circulation flow channel may be configured for circulation in the printing head 2 to discharge the aqueous ink composition from a main route through the discharge path and return the aqueous ink composition to the main route, or may be configured to discharge the aqueous ink composition from the printing head 2 for external circulation and return the discharged ink composition to the printing head. In view of easy manufacture, the former circulation is beneficial.

The printing head having the circulation flow channel described above can maintain reliable ejection of the aqueous ink composition even if the solute content in the aqueous ink composition is increased by drying.

Although a serial printing head has been described in the above embodiment, the printing head 2 may be a line head. The line head, as well the serial head, can maintain reliable ejection of the aqueous ink composition by circulating the aqueous ink composition to reduce thickening by drying. The printing head of a line printing apparatus has nozzles in an arrangement with a length more than or equal to the width of the printing medium and is operable to apply the aqueous ink composition onto the printing medium during one scanning operation.

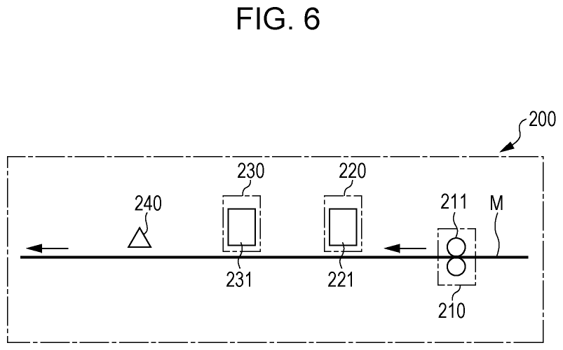

FIG. 6 is a schematic sectional diagram of a portion of a line head printing apparatus including a line head (line printing head) and operable to perform a line printing method. A section 200 of the printing apparatus includes a aqueous ink composition applying unit 220 including a printing head 221 for an aqueous ink composition, a liquid composition applying unit 230 including a printing head 231 for a liquid composition, a printing medium transport unit 210 including rollers 211 operable to transport the printing medium M, and a post-application heating device 240 operable for post-application heating. The printing heads 231 and 221 are line heads having nozzles in an arrangement extending in the width direction of the printing medium M that is the direction from the front to the back in FIG. 6.

The line printing apparatus applies the aqueous ink composition onto the printing medium M by ejecting the aqueous ink composition while transporting the printing medium M in the direction indicated by the arrow shown in FIG. 6 for relative movement of the printing heads 231 and 221 to the printing medium M. This relative movement is referred to as scanning operation Such scanning operation of a line head and the main scanning operation of a serial head are often referred to as pass. In a line printing method, the aqueous ink composition and the liquid composition are applied, during one pass, from the printing heads onto the printing medium M being transported.

The line printing apparatus may be the same as the above-described serial printing apparatus 1 except for including a line printing head and operable to perform the line printing method. The line printing apparatus may include a drying device for a drying step. For example, a drying device such as the ventilation fan 8 or the IR heater 3 over the printing head 2 in FIG. 1 may be provided over the printing heads 231 and 221 in FIG. 6, and a drying device, such as an under-heater corresponding to the platen heater 4 under the printing head 2 in FIG. 1, may be provided under the printing heads 231 and 221 in FIG. 6.

### 3. Ink Jet Printing Method

The ink jet printing method disclosed herein includes an application step of ejecting an aqueous ink composition from a printing head to apply the ink composition onto a printing medium. The printing head has a circulation flow channel through which the aqueous ink composition circulates in the printing head. The aqueous ink composition contains at least one organic solvent in a proportion of 15.0% or less relative to the total mass of the ink composition, and the content of organic solvent having a normal boiling pint of more than 280.0° C. is limited to 3.0% or less relative to the total mass of the ink composition.

### 3. 1. Printing Medium

The printing medium used in the ink jet printing method disclosed herein may be, but is not limited to, a poorly absorbent or non-absorbent printing medium. The poorly absorbent or non-absorbent printing medium mentioned herein refers to a printing medium that hardly absorbs or does not absorb ink. More specifically, the poorly absorbent or non-absorbent printing medium exhibits a water absorption of 10 mL/m² or less for a period of 30 ms^{1/2} from the beginning of contact with water, measured by Bristow's method. The Bristow's method is broadly used for measuring liquid absorption in a short time, and Japan Technical Association of the Pulp and Paper Industry (JAPAN TAPPI) officially adopts this method. Details of this method are specified in Standard No. 51 of “JAPAN TAPPI Kami Pulp Shiken Hou 2000-nen Ban” (JAPAN TAPPI Pulp and Paper Test Methods, edited in 2000). Such a non-absorbent printing medium may be a medium not provided with an ink-absorbent ink-receiving layer at the printing side thereof or a medium coated with a poorly ink-absorbent layer at the printing side thereof.

More specifically, the non-absorbent printing medium may be, but is not limited to, a plastic film not provided with an ink-absorbent layer, or a paper sheet or any other base material coated or bonded with a plastic film. The term plastic mentioned here may be polyvinyl chloride, polyethylene terephthalate, polycarbonate, polystyrene, polyurethane, or polypropylene. Polyolefin includes polyethylene and polypropylene. Polyolefin films are flexible and are therefore useful for use in the printing method disclosed herein but do not allow ink to be firmly fixed to the printing medium. However, polyolefin films help to achieve high fastness and are therefore useful in the present embodiment.

The aqueous ink composition disclosed herein is particularly useful in printing on poorly absorbent printing media. The poorly absorbent printing medium may be, but is not limited to, coated paper including a coating layer at the surface thereof for receiving oil-based ink. The coated paper may be, but is not limited to, book-printing paper, such as art paper, coat paper, or matte paper.

The aqueous ink composition disclosed herein can be favorably applied onto such non-ink-absorbent or poorly ink-absorbent printing media and form an image or coating having high fixability and high rub-fastness at a high speed. Also, poorly absorbent or non-absorbent printing media do not readily absorb the solvent of ink and cause an amount of solvent to remain on the printing medium, resulting in degraded rub-fastness or fixability of the printed item. The aqueous ink composition disclosed herein, however, can form printed items with high fastness.

The printing medium may be in the form of a bag or a sheet or any other form. A polymer film bag is particularly useful as the printing medium. In some embodiments of the ink jet printing method disclosed herein, the printing medium, onto which the aqueous ink composition is applied, may mainly contain polyolefin, such as polyethylene or polypropylene. Although adhesion to such a printing medium is generally difficult, the aqueous ink composition disclosed herein can form images having high fixability and high rub-fastness even on such a printing medium. In an embodiment, the printing medium may be surface-treated in advance with corona or plasma to reduce ink separation from the printing medium.

### 3. 2. Application Step

In the application step, the aqueous ink composition is ejected from a printing head having a circulation flow channel through which the aqueous ink composition circulates in the head, thus applied onto a printing medium. For applying the aqueous ink composition, a serial printing apparatus or a line printing apparatus may be used.

In an application step using a line printing apparatus, the printing medium may be transported at a rate of 30.0 m/min or more. Since the ink jet printing method disclosed herein uses the above-described aqueous ink composition, which can dry quickly, the speed of transporting the printing medium can be increased. The speed of transporting the printing medium may be 30.0 m/min or more, for example, in a range of 50.0 m/min to 300.0 m/min or 70.0 m/min to 200.0 m/min.

### 3. 3. Other Steps

In an embodiment, the ink jet printing method may include a plurality of application steps. In an embodiment, the ink jet printing method may further include a drying step of drying liquid applied onto the printing medium, a post-application heating step of heating the printing medium, and a lamination step.

### 3. 3. 1. Drying Step

The ink jet printing method may include a drying step. A drying step of drying the printing medium may be performed before or during the application step for the aqueous ink composition. The drying step may be performed by allowing the printing medium to stand in a pause of printing or by using a drying mechanism. The drying mechanism for drying may be a blowing type operable to blow the printing medium with ambient air having normal temperature or warm air, a radiation type operable to irradiate the printing medium with heat-generating radiation, such as infrared radiation, or a conduction type operable to conduct heat to the printing medium in contact therewith. These mechanisms may be used in combination. In some embodiments, a blowing-type drying mechanism may be used. The drying step using a drying mechanism is intended to dry rapidly the ink composition applied onto the printing medium. The drying step, if performed, helps the ink on the printing medium to dry, thus reducing bleeding affecting image quality.

In an embodiment, however, the drying step using a drying mechanism may be omitted. The aqueous ink composition disclosed herein limits the organic solvent content and can, therefore, dry quickly. Accordingly, the ink composition on the printing medium is less likely to bleed and degrade image quality even though the drying step using a drying mechanism is omitted. In addition, if the drying step using a drying mechanism is not performed, the aqueous ink composition is not likely to cause clogging and can wet and spread across the printing medium, thus improving image quality.

The surface temperature of the printing medium during the application of the aqueous ink composition may be 45.0° C. or less, for example, 43.0° C. or less, 40.0° C. or less, 38.0° C. or less, 35.0° C. or less, 32.0° C. or less, 30.0° C. or less, or 28.0° C. or less. Also, the upper limit of the surface temperature may be 20.0° C. or more, for example, 23.0° C. or more, 25.0° C. or more, 28.0° C. or more, 30.0° C. or more, or 32.0° C. or more.

For example, the surface temperature may be controlled in the range of 20.0° C. to 45.0° C. In some embodiments, the surface temperature may be controlled in the range of 27.0° C. to 45.0° C., 28.0° C. to 43.0° C., 30.0° C. to 40.0° C., or 32.0° C. to 38.0° C. The surface temperature is the temperature of a portion of the printing medium subjected to ink application and is the highest temperature at the portion during the application step. A lower surface temperature outside the above ranges is beneficial from the viewpoint of relieving degradation of image quality, reducing clogging, and increasing gloss. In contrast, a higher surface temperature outside the above ranges is beneficial from the viewpoint of increasing fastness and spreading the ink composition over the printing medium for high-quality images.

The surface temperature of the printing medium during ink application may be adjusted to relatively high by performing the drying step using a drying mechanism or may be kept relatively low by omitting the drying step.

The drying step may be performed simultaneously with one or two or more application steps. If the drying step is performed simultaneously with an application step, the surface temperature of the printing medium may be controlled to 43.0° C. or less, for example, 40.0° C. or less. The drying step performed simultaneously with the application step may be referred to as a primary heating step.

### 3. 3. 2. Post-Application Heating Step

The ink jet printing method disclosed herein may further include a post-application heating step of heating the printing medium after the application step. The post-application step may be referred to as a secondary heating step. For the post-application heating, a heating device may be used, if necessary. For example, an after-heater (corresponding to the secondary heater 5 in the ink jet printing apparatus described above) may be used. Any appropriate drying device may be used without limitation to such a heating device of the ink jet printing apparatus. By drying the printing medium by the post-application heating, the printed image can be sufficiently fixed, and the resulting printed item can be used immediately after printing.

In this instance, the temperature of the printing medium is not particularly limited but may be set in view of, for example, the glass transition temperature (Tg) of the resin of the polymer particles contained in the printed item. If the Tg of the resin of the polymer particles is taken into account, the temperature of the printing medium may be set higher than the Tg of the resin of the polymer particles by 5.0° C. or more, for example, by 10.0° C. or more.

The post-application heating may increase the surface temperature of the printing medium to 30.0° C. to 120.0° C., for example, 40.0° C. to 100.0° C., 50.0° C. to 95° C., or 70° C. to 90° C. In some embodiments, the printing medium may be heated to a surface temperature of 80° C. or more by the post-application heating. When the printing medium is heated to such a temperature, the polymer particles in the printed item can be formed into a coating and thus form a flat surface, and the image of the printed item can be dried and sufficiently fixed.

Furthermore, since the ink jet printing method disclosed herein uses the above-described aqueous ink composition, which can dry quickly, printed images can dry at a low energy.

### 3. 3. 3. Lamination Step

In an embodiment according to the present disclosure, the printing medium subjected to one or more application steps may be laminated after printing, thus completing a printed item. The lamination step of laminating the printing medium may be performed by covering the printed surface of the printing medium with a protective film by lamination. Lamination may be performed as, but not limited to, follows: a film and the printed surface of a printed item may be pasted together after a known adhesive is applied onto the printed surface, or a film with an adhesive applied thereto and the printed surface of a printed item may be pasted together. Alternatively, a melted resin prepared by melting a film may be extruded onto the printed surface of a printed item to form a coating film over the printed surface. The film used for lamination may be a resin film. Laminated printed items are superior in rub-fastness and are protected from impact with a hard solid or any other severe handling. The laminated printed item may be heated or pressed at room temperature for sufficient adhesion.

In an embodiment, however, the printing medium subjected to one or more application steps may be used as a printed item as it is without lamination.

### 4. Printing Head Set

In an embodiment of the present disclosure, the printing head and the aqueous ink composition may constitute a printing head set. The printing head set includes an aqueous ink composition, and a printing head operable to eject the aqueous ink composition. This printing head has a circulation flow channel through which the aqueous ink composition circulates and is used in an ink jet printing method to eject the aqueous ink composition to apply the ink composition onto a printing medium. The aqueous ink composition, the printing head, and the printing method that have been described herein can be applied to the printing head set.

### 5. Examples and Comparative Examples

The subject matter of the present disclosure will be further described in detail with reference to the following Examples and Comparative Examples. However, it is not limited to the Examples, and various modifications may be made unless departing from the scope and spirit of the present disclosure. In the following description, “%” and “part(s)” are on a mass basis unless otherwise specified.

### 5. 1. Preparation of Aqueous Ink Compositions

Different compositions shown in Tables 1 and 2 were prepared as Inks 1 to 17 (aqueous ink compositions). Each Ink was prepared by stirring the constituents shown in Table 1 or 2 with a magnetic stirrer for 2 hours in a container, followed by filtering through a membrane filter of 5 m in pore size to remove impurities, such as foreign substances and coarse particles. All the values in Tables 1 and 2 are represented by mass % (percent by mass), and pure water was added so that the total mass of the composition came to 100% by mass.

C.I. Pigment Blue 15:3 that is a coloring material used in the Inks was mixed with a water-soluble styrene-acrylic resin acting as a pigment dispersant (not shown in the Tables) in a ratio of pigment:pigment dispersion=2:1 and then dispersed in water before use, and the thus prepared pigment dispersion liquid was used for preparing the inks. The content of the coloring material presented in the Tables was calculated from the solid content of the pigment dispersion liquid and represented by mass %. For the content of polymer particles presented in Tables 1 and 2, it is the net solid content of the polymer particles introduced from the polymer particle emulsion.

TABLE 1
(mass %)

| | | Ink 1 | Ink 2 | Ink 3 | Ink 4 | Ink 5 | Ink 6 | Ink 7 | Ink 8 | Ink 9 | Ink 10 |
|---|---|---|---|---|---|---|---|---|---|---|---|
| Coloring material | C.I. Pigment Blue 15:3 | 7.0 | 7.0 | 7.0 | 7.0 | 7.0 | 7.0 | 7.0 | 7.0 | 7.0 | 7.0 |
| Polymer particles | SUPERFLEX 210 | — | — | — | — | — | — | — | — | — | — |
| | VONCOAT AN-1190S | 5.0 | 5.0 | 5.0 | 5.0 | 5.0 | 5.0 | 5.0 | 5.0 | 5.0 | 5.0 |
| | VONCOAT Y-651 | — | — | — | — | — | — | — | — | — | — |
| | VONCOAT AC-501 | — | — | — | — | — | — | — | — | — | — |
| | VONCOAT AN-1170 | — | — | — | — | — | — | — | — | — | — |
| Organic solvent | 1,2-Propanediol | — | — | — | 5.0 | 5.0 | 5.0 | 5.0 | 5.0 | 5.0 | — |
| | 1,3-Propanediol | — | — | 5.0 | — | — | — | — | — | — | — |
| | 1,2-Hexanediol | 1.0 | 5.0 | — | — | 5.0 | — | — | 12.0 | — | — |
| | Butyl triglycol | — | — | — | — | — | 5.0 | — | — | — | — |
| | Glycerin | — | — | — | — | — | — | 1.0 | — | 5.0 | — |
| (Total organic solvent content) | | 1.0 | 5.0 | 5.0 | 5.0 | 10.0 | 10.0 | 6.0 | 17.0 | 10.0 | 0.0 |
| Surfactant | BYK348 | 0.5 | 0.5 | 0.5 | 0.5 | 0.5 | 0.5 | 0.5 | 0.5 | 0.5 | 0.5 |
| pH adjuster | Triisopropanolamine | 0.1 | 0.1 | 0.1 | 0.1 | 0.1 | 0.1 | 0.1 | 0.1 | 0.1 | 0.1 |
| Preservative/fungicide | Proxel XL2 | 0.1 | 0.1 | 0.1 | 0.1 | 0.1 | 0.1 | 0.1 | 0.1 | 0.1 | 0.1 |

| | | | | | | | | | | |
|---|---|---|---|---|---|---|---|---|---|---|
| Pure water | Balance | Balance | Balance | Balance | Balance | Balance | Balance | Balance | Balance | Balance |

TABLE 2
(mass %)

| | | Ink 11 | Ink 12 | Ink 13 | Ink 14 | Ink 15 | Ink 16 | Ink 17 |
|---|---|---|---|---|---|---|---|---|
| Coloring material | C.I. Pigment Blue 15:3 | 7.0 | 7.0 | 7.0 | 7.0 | 7.0 | 7.0 | 7.0 |
| Polymer particles | SUPERFLEX 210 | — | 5.0 | — | — | — | — | — |
| | VONCOAT AN-1190S | 2.0 | — | — | — | — | 5.0 | 8.0 |
| | VONCOAT Y-651 | — | — | 5.0 | — | — | — | — |
| | VONCOAT AC-501 | — | — | — | 5.0 | — | — | — |
| | VONCOAT AN-1170 | — | — | — | — | 5.0 | — | — |
| Organic solvent | 1,2-Propanediol | — | — | — | — | — | 6.0 | — |
| | 1,3-Propanediol | — | — | — | — | — | — | — |
| | 1,2-Hexanediol | 5.0 | 5.0 | 5.0 | 5.0 | 5.0 | 7.0 | 5.0 |
| | Butyl triglycol | — | — | — | — | — | — | — |
| | Glycerin | — | — | — | — | — | — | — |
| (Total organic solvent content) | | 5.0 | 5.0 | 5.0 | 5.0 | 5.0 | 13.0 | 5.0 |
| Surfactant | BYK348 | 0.5 | 0.5 | 0.5 | 0.5 | 0.5 | 0.5 | 0.5 |
| pH adjuster | Triisopropanolamine | 0.1 | 0.1 | 0.1 | 0.1 | 0.1 | 0.1 | 0.1 |
| Preservative/fungicide | Proxel XL2 | 0.1 | 0.1 | 0.1 | 0.1 | 0.1 | 0.1 | 0.1 |

| | | | | | | | |
|---|---|---|---|---|---|---|---|
| Pure water | Balance | Balance | Balance | Balance | Balance | Balance | Balance |

The materials presented in Tables 1 and 2 are as follows:

Superflex 210 (Tg: 41.0° C.), urethane resin produced by Dai-ichi Kogyo Seiyaku

VONCOAT AN-1190S (Tg: 25.0° C.), acrylic resin produced by DIC

VONCOAT YG-651 (Tg: 47.0° C.), acrylic resin produced by DIC

VONCOAT AC-501 (Tg: 7.0° C.), acrylic resin produced by DIC

VONCOAT AN-1170 (Tg: 60.0° C.), acrylic resin produced by DIC

1,2-Propanediol (normal boiling point: 188.0° C.)

1,3-Propanediol (normal boiling point: 214.0° C.)

1,2-Hexanediol (normal boiling point: 223.0° C.)

Butyl triglycol (BTG, normal boiling point: 278.0° C.)

Glycerin (normal boiling point: 290.0° C.)

BYK 348, silicone surfactant produced by BYK

Triisopropanolamine (pH adjuster)

Proxel XL2, Preservative/fungicide produced by produced by Lonza

### 5. 2. Evaluation

### 5. 2. 1. Printing Test

A line printer was prepared by modifying Seiko Epson L-4533A. The printing head was configured for one pass printing such that that the printing medium was continuously transported with the head fixed in position during printing. The surface temperature (highest temperature in printing) of the printing medium was measured at a position opposing the printing head with a platen heater operating. The temperatures thus measured are presented as primary heating temperatures in Tables 3 to 5. In the Example at 25° C., no drying mechanism was used with the platen heater off. The line printer was prepared by arranging printing heads having a circulation mechanism and a nozzle alignment with a length of 1 inch in a staggered manner across the width of the printing medium. The printing medium used was an oriented polypropylene (OPP) PYLEN P2102, manufactured by Toyobo.

The printing medium was heated for drying to 80° C. (highest temperature) with a secondary heating mechanism provided downstream from the printing head.

The circulation flow rate represents an amount, for individual one head, of aqueous ink composition discharged for circulation from the printing head through a circulation flow channel. More specifically, it represents the amount of ink discharged from the printing head during printing. The circulation flow rate was controlled to the presented value by adjusting the amount of ink to be fed to the printing head. In Comparative Examples 4 and 5, the circulation flow channels of the printing heads were closed so as not to circulate the ink, not having any circulation flow rate. The number of nozzles was 360 per printing head. The density of nozzles in the arrangement was 360 dpi.

The pattern printed was a solid square pattern measuring 20 cm by 20 cm, and in which the aqueous ink composition was applied at a rate of 10 mg/inch².

The printing speed is the speed of transporting the printing medium and is presented in Tables 3 to 5. The circulation flow rate and the primary heating temperature are also presented in Tables 3 to 5.

### 5. 2. 2. Rub-Fastness Under Dry Condition

The printed solid pattern was rubbed reciprocally 100 times at a speed of 30 times per minute with a Gakushin-type rubbing tester AB-301 (manufacture by TESTER SANGYO) under conditions where a load of 200 g was placed on a dried white cotton cloth for rubbing test. The rub-fastness was estimated by visual observation and rated according to the following criteria. The test results are presented in Tables 3 to 5.

A: The patter did not exhibit any changes even by rubbing 100 times or more.

B: Some flaws were left in the pattern at a point in time of rubbing 100 times but did not affect the pattern.

C: The pattern exhibited changes by rubbing 51 times to 99 times.

D: The pattern exhibited changes by rubbing 50 times or less.

### 5. 2. 3. Rub-Fastness Under Wet Condition

The printed solid pattern was rubbed reciprocally 10 times at a speed of 30 times per minute with a Gakushin-type rubbing tester AB-301 (manufacture by TESTER SANGYO) under conditions where a load of 200 g was placed on a 100% water-wetted white cotton rubbing test cloth. The rub-fastness was estimated by visual observation and rated according to the following criteria. The test results are presented in Tables 3 to 5.

A: The patter did not exhibit any changes even by rubbing 10 times or more.

B: Some flaws were left in the pattern at a point in time of rubbing 10 times but did not affect the pattern.

C: The pattern exhibited changes by rubbing 5 times to 9 times.

D: The pattern exhibited changes by rubbing 4 times or less.

### 5. 2. 4. Lamination Strength

A dry lamination adhesive (base material TM-329 and curing agent CAT-8B, produced by Toyo-Morton) was applied onto an OPP film with a bar coater, and the OPP sheet and a cast polypropylene (CPP) film PYLEN P1128 manufactured by Toyobo) were bonded together, followed by aging at 40° C. for 48 hours. The laminated film was cut into a 15 mm-wide piece. The strength of the piece was measured with a T-type separation test (test device: universal test machine Tensilon RTG-1250A, manufactured A&D Company), and the lamination strength was evaluated according to the following criteria. The test results are presented in Tables 3 to 5. Lamination strength is not only the strength of a laminated printed article but also a measure of how firmly the ink composition is fixed to the printing medium.

A: 5 N/15 mm or more

B: 3 N/15 mm to less than 5 N/15 mm more

C: 1 N/15 mm to less than 15N/15 mm more

D: less than 1 N/15 mm

### 5. 2. 5. Resistance to Blocking and Image Transfer

A load of 5 kgf/cm² was placed on a solid image portion of the printed sample with a blocking tester CO-201 (manufactured by Tester Sangyo) in a state where another film overlies the solid image with the untreated side thereof (not subjected to corona treatment) in contact with the solid image portion. In this state, the printed sample was allowed to stand at 40.0° C. for 24 hours. The degree of blocking was evaluated according to the degree of image transfer when the film was removed. The test results are presented in Tables 3 to 5.

A: The image was not transferred.

B: The removed film was slightly sticky, but the image was not affected.

C: A portion of the image was transferred.

D: 50% or more of the area of the image was transferred.

### 5. 2. 6. Anti-Clogging

Simulation printing without ejecting ink through nozzles was continued for a predetermined period of time under a printing condition. After the predetermined period passed, ejection was checked for failure in ejection through the nozzles and deviation in position of droplets. Resistance to clogging (anti-clogging property) was evaluated according to the following criteria. The test results are presented in Tables 3 to 5. The nozzles were in idleness where ink was not ejected therethrough during the continuous printing for the predetermined period. Hence, the predetermined period is the period for which the nozzles were allowed to stand in idleness.

A: No nozzles caused deviation or failure after idleness for 120 minutes or more.

B: Deviation and failure did not occur after idleness for 60 minutes or more, but occurred after idleness for 120 minutes.

C: Deviation and failure did not occur after idleness for 30 minutes or more, but occurred after idleness for 60 minutes.

D: Deviation and failure did not occur after idleness for 10 minutes or more, but occurred after idleness for 30 minutes.

### 5. 2. 7. Image Quality

It was visually checked whether or not there were streaks in the transport direction in the printed pattern. In the case of using a line printer, if ink does not sufficiently wet or spread across the printing medium, ink droplets do not land on intended positions due to slight displacement of nozzles or deviation of ink droplets in landing. This causes streaks in the printed pattern. The printed patterns were visually observed and evaluated according to the following criteria. The test results are presented in Tables 3 to 5.

A: No streaks were seen.

B: Streaks were seen to some extent.

C: Streaks were conspicuous.

D: Many streaks occurred.

TABLE 3

| | Example | Example | Example | Example | Example | Example | Example | Example | Example | Example |
|---|---|---|---|---|---|---|---|---|---|---|
| | 1 | 2 | 3 | 4 | 5 | 6 | 7 | 8 | 9 | 10 |
| Ink | Ink 1 | Ink 1 | Ink 1 | Ink 2 | Ink 3 | Ink 4 | Ink 5 | Ink 6 | Ink 7 | Ink 11 |
| Circulation | 12.0 | 10.0 | 3.0 | 3.0 | 3.0 | 3.0 | 3.0 | 3.0 | 3.0 | 3.0 |
| flow rate | | | | | | | | | | |
| (g/min) | | | | | | | | | | |
| Printing speed | 50.0 | 50.0 | 50.0 | 50.0 | 50.0 | 50.0 | 50.0 | 50.0 | 50.0 | 50.0 |
| (m/min) | | | | | | | | | | |
| Primary heating | 35.0 | 35.0 | 35.0 | 35.0 | 35.0 | 35.0 | 35.0 | 35.0 | 35.0 | 35.0 |
| temperature (° C.) | | | | | | | | | | |
| Rub fastness | A | A | A | A | A | A | A | A | B | B |
| (Dry) | | | | | | | | | | |
| Rub fastness | A | A | A | A | A | A | A | A | B | B |
| (Wet) | | | | | | | | | | |
| Laminate strength | A | A | A | B | A | A | B | B | C | C |
| Blocking/transfer | A | A | A | A | A | A | B | B | B | A |
| Anti-clogging | A | B | C | B | A | A | A | A | A | A |
| Image quality | B | B | B | A | C | C | A | B | C | A |

TABLE 4

| | Example | Example | Example | Example | Example | Example | Example | Example | Example | Example | Example |
|---|---|---|---|---|---|---|---|---|---|---|---|
| | 11 | 12 | 13 | 14 | 15 | 16 | 17 | 18 | 19 | 20 | 21 |
| Ink | Ink 12 | Ink 13 | Ink 14 | Ink 15 | Ink 16 | Ink 17 | Ink 2 | Ink 6 | Ink 6 | Ink 6 | Ink 6 |
| Circulation | 3.0 | 3.0 | 3.0 | 3.0 | 3.0 | 3.0 | 2.0 | 3.0 | 3.0 | 3.0 | 3.0 |
| flow rate | | | | | | | | | | | |
| (g/min) | | | | | | | | | | | |
| Printing speed | 50.0 | 50.0 | 50.0 | 50.0 | 50.0 | 50.0 | 50.0 | 80.0 | 30.0 | 50.0 | 50.0 |
| (m/min) | | | | | | | | | | | |
| Primary heating | 35.0 | 35.0 | 35.0 | 35.0 | 35.0 | 35.0 | 35.0 | 35.0 | 35.0 | 40.0 | 25.0 |
| temperature (° C.) | | | | | | | | | | | |
| Rub fastness | B | A | C | A | A | A | A | A | A | A | A |
| (Dry) | | | | | | | | | | | |
| Rub fastness | A | B | A | C | B | A | A | B | A | A | A |
| (Wet) | | | | | | | | | | | |
| Laminate strength | A | B | A | C | C | A | B | C | A | A | B |
| Blocking/transfer | A | A | C | A | C | A | A | C | A | B | B |
| Anti-clogging | A | A | C | A | A | B | C | A | A | B | A |
| Image quality | A | A | A | A | A | A | A | C | A | C | A |

TABLE 5

| | Comparative | Comparative | Comparative | Comparative | Comparative |
|---|---|---|---|---|---|
| | Example 1 | Example 2 | Example 3 | Example 4 | Example 5 |
| Ink | Ink 8 | Ink 9 | Ink 10 | Ink 2 | Ink 8 |
| Circulation flow rate | 3.0 | 3.0 | 3.0 | — | — |
| (g/min) | | | | | |
| Printing speed | 50.0 | 50.0 | 50.0 | 50.0 | 50.0 |
| (m/min) | | | | | |
| Primary heating | 35.0 | 35.0 | 35.0 | 35.0 | 35.0 |
| temperature (° C.) | | | | | |
| Rub fastness (Dry) | B | C | A | A | B |
| Rub fastness (Wet) | B | C | A | A | B |
| Laminate strength | C | D | A | B | C |
| Blocking/transfer | D | D | A | A | D |
| Anti-clogging | A | A | D | D | B |
| Image quality | A | C | D | A | A |

### 5. 3. Evaluation Results

Any of the Examples produced satisfactory results in drying speed on the printing medium (resistance to blocking and transfer), lamination strength, and ejection consistency (anti-clogging). In the Examples, all the inks were ejected from the printing head having a circulation flow channel, and the inks contained 15.0% or less of organic solvent relative to the total mass of the ink, in which the content of organic solvents having a normal boiling point of more than 280.0° C. was limited to 3.0% or less of the total mass of the ink composition.

In contrast, the results of the Comparative Examples apart from the conditions of the Examples were unsatisfactory in terms of drying speed on the printing medium (resistance to blocking and transfer) or ejection consistency (anti-clogging). The results will be described in detail below.

In comparison between Examples 3 and 4 and between 7 and 15, one example in which the organic solvent content was higher was superior in anti-clogging, while the other was superior in resistance to blocking and transfer and lamination strength.

The results of Examples 4 to 6, 5, and 8 show that inks containing alkylene glycol ether or alkanediol having a carbon number of 5 or more as the organic solvent were able to spread sufficiently across the printing medium and formed high-quality images. The case of containing polyol as the organic solvent exhibited superior anti-clogging.

The results of Examples 11 to 14, 16, and 2 show that inks containing polymer particles having a low glass transition temperature resulted in high lamination strength and high fixability, that is, or high rub-fastness. Also, use of polymer particles having a high glass transition temperature led to satisfactory resistance to blocking and high rub-fastness resulting from high hardness.

In comparison between Examples 1 and 2 and the like, the higher circulation flow rate led to more satisfactory anti-clogging.

In comparison among Examples 20, 21, and 8, lower primary heating temperatures led to more satisfactory anti-clogging and caused the ink to spread across the printing medium and produce high image quality. Also, higher primary heating temperatures led to higher lamination strength. When the sample of Example 4 was not subjected to primary drying at 25° C., the anti-clogging was rated as A (not presented in the Tables). This suggests that clogging can be reduced by omitting the drying step. When the sample of Comparative Example 1 was not subjected to primary heated at 25° C., no streaks occurred and, therefore, image quality was rated as A, while image quality in terms of evenness was reduced due to ink bleeding. This phenomenon occurred only in the case where Ink 8 containing more than 15% by mass of organic solvent was used under a condition of omitting the drying step and did not occur in any other cases. This suggests that the ink composition according to the present disclosure can dry quickly and that the use thereof can reduce image degradation in spite of omitting the drying step.

On the other hand, Comparative Example 1, in which the ink contained more than 15% by mass of organic solvent, resulted in inferior resistance to blocking and transfer.

Comparative Example 2, in which the ink contained more than 3% by mass of organic solvent having a normal boiling point of more than 280° C., resulted in inferior resistance to blocking and reduced lamination strength.

Comparative Example 3, in which the ink did not contain organic solvent, resulted in insufficient anti-clogging.

Comparative Example 4, in which the ink was not circulated in the printing head, resulted in insufficient anti-clogging. In Comparative Example 5, in which the ink contained more than 15% by mass of organic solvent, the anti-clogging was not bad in spite of no circulation, but the resistance to blocking and transfer was poor. These results suggest that when an ink containing 15% by mass or less of organic solvent is used from the viewpoint of obtaining high fastness, it is beneficial to circulate for satisfactory anti-clogging.

The implementation of the subject matter disclosed herein is not limited to the above-described embodiments, and various modifications may be made. For example, the subject matter disclosed herein may be implemented in substantially the same manner as any of the disclosed embodiments (for example, in terms of function, method, and results, or in terms of purpose and effect). Some elements used in the disclosed embodiments but not essential may be replaced. Implementations capable of producing the same effect as produced in the disclosed embodiments or achieving the same object as in the disclosed embodiments are also within the scope of the subject matter of the present disclosure. A combination of any of the disclosed embodiments with a known art is also within the scope of the subject matter of the present disclosure.

What is claimed is:

1. An ink jet printing method, comprising:
an application step of ejecting an aqueous ink composition from a printing head to apply the aqueous ink composition onto a poorly absorbent or non-absorbent printing medium,
the aqueous ink composition containing at least one organic solvent in a proportion of 1.0% to 13.0% relative to the total mass of the aqueous ink composition, the at least one organic solvent including an organic solvent having a normal boiling point of 150.0° C. to 280.0° C., the content of organic solvents having a normal boiling point of more than 280.0° C. being limited to 3.0% or less of the total mass of the ink composition,
the printing head having a circulation flow channel through which the aqueous ink composition circulates in the printing head.

2. An aqueous ink composition, comprising:
at least one organic solvent in a proportion of 15.0% or less relative to the total mass of the ink composition, wherein
the content of organic solvents having a normal boiling point of more than 280.0° C. is limited to 3.0% or less of the total mass of the ink composition, and
the aqueous ink composition is ejected for printing from a printing head having a circulation flow channel through which the aqueous ink composition circulates in the printing head.

3. The aqueous ink composition according to claim 2, wherein
the total content of the at least one organic solvent is 1.0% to 13.0% relative to the total mass of the aqueous ink composition.

4. The aqueous ink composition according to claim 2, wherein,
the at least one organic solvent includes an organic solvent having a normal boiling point of 170.0° C. to 280.0° C.

5. The aqueous ink composition according to claim 2, wherein
the at least one organic solvent includes an organic solvent having a normal boiling point of 280.0° C. or less selected from the group consisting of polyols, alkylene glycol ethers, and alkanediols having a carbon number of 5 or more.

6. The aqueous ink composition according to claim 2, further comprising polymer particles.

7. The aqueous ink composition according to claim 6, wherein
the content of the polymer particles is 1.0% by mass to 15.0% by mass.

8. The aqueous ink composition according to claim 6, wherein
the polymer particles have a glass transition temperature of −30.0° C. to 50.0° C.

9. The aqueous ink composition according to claim 2, wherein
the aqueous ink composition is circulated at a rate of 1.0 g/min to 7.0 g/min per printing head.

10. The aqueous ink composition according to claim 2, wherein
the printing head has a pressure chamber operable to apply a pressure to the aqueous ink composition to eject the aqueous ink composition through a nozzle, and
the circulation flow channel has a route that causes the aqueous ink composition flowing from the pressure chamber to circulate.

11. The aqueous ink composition according to claim 2, wherein
the printing head is a line head having nozzles in an arrangement with a length more than or equal to the width of the printing medium and is operable to apply the aqueous ink composition onto the printing medium during one scanning operation.

12. The aqueous ink composition according to claim 2, wherein
the at least one organic solvent has a total content of 1.0% by mass to 10.0% by mass.

13. A printing head set comprising:
an aqueous ink composition containing at least one organic solvent in a proportion of 15.0% or less relative to the total mass of the ink composition, the content of organic solvents having a normal boiling point of more than 280.0° C. being limited to 3.0% or less of the total mass of the ink composition; and
a printing head having a circulation flow channel through which the aqueous ink composition circulates and being operable to eject the aqueous ink composition, for printing, onto a printing medium.

14. The printing head set according to claim 13, wherein
the printing head is a line head having nozzles in an arrangement with a length more than or equal to the width of the printing medium and is operable to print on the printing medium during one scanning operation.

15. An ink jet printing method, comprising:
an application step of ejecting an aqueous ink composition from a printing head to apply the aqueous ink composition onto a printing medium,
the aqueous ink composition containing at least one organic solvent in a proportion of 15.0% or less relative to the total mass of the ink composition, the content of organic solvents having a normal boiling point of more than 280.0° C. being limited to 3.0% or less of the total mass of the ink composition,
the printing head having a circulation flow channel through which the aqueous ink composition circulates in the printing head.

16. The ink jet printing method according to claim 15, wherein
the printing head is a line head having nozzles in an arrangement with a length more than or equal to the width of the printing medium and is operable to perform the application step on the printing medium during one scanning operation.

17. The ink jet printing method according to claim 16, wherein
the application step includes transporting the printing medium at a rate of 30.0 m/min or more.

18. The ink jet printing method according to claim 15, further comprising a drying step of drying the aqueous ink composition applied onto the printing medium with a drying mechanism during the application step.

19. The ink jet printing method according to claim 15, wherein
the printing medium has a surface temperature of 45.0° C. or less in the application step.

20. The ink jet printing method according to claim 15, further comprising a post-application heating step of heating the printing medium after the application step.

21. The ink jet printing method according to claim 15, wherein
the printing medium is a polymer film.

22. The ink jet printing method according to claim 15, wherein
the aqueous ink composition is circulated at a rate of 1.0 g/min to 7.0 g/min per printing head.

23. The ink jet printing method according to claim 15, wherein
the aqueous ink composition applied onto the printing medium is not subjected to drying with a drying mechanism during the application step.

24. An ink jet printing apparatus comprising:
an aqueous ink composition containing at least one organic solvent in a proportion of 15.0% or less relative to the total mass of the ink composition, the content of organic solvents having a normal boiling point of more than 280.0° C. being limited to 3.0% or less relative to the total mass of the aqueous ink composition; and
a printing head having a circulation flow channel through which the aqueous ink composition circulates and being operable to eject the aqueous ink composition to apply the ink composition onto a printing medium.

25. The ink jet printing apparatus according to claim 24, wherein
the aqueous ink composition contains at least one organic solvent in a proportion of 1.0% to 13.0% relative to the total mass of the ink composition, and the at least one organic solvent includes an organic solvent having a normal boiling point of 150.0° C. to 280.0° C., and wherein
the printing medium is poorly absorbent or not absorbent.
